(19) United States
(12) Patent Application Publication
(10) Pub. No.: US 2026/0046901 A1
(43) Pub. Date: Feb. 12, 2026

(54) SIDELINK CONFLICT DETERMINATION FOR HIDDEN NODES

(71) Applicant: QUALCOMM Incorporated, San Diego, CA (US)

(72) Inventors: Shaozhen GUO, Beijing (CN); Changlong XU, Beijing (CN); Jing SUN, San Diego, CA (US); Chih-Hao LIU, San Diego, CA (US); Xiaoxia ZHANG, San Diego, CA (US); Luanxia YANG, Beijing (CN); Siyi CHEN, Beijing (CN)

(21) Appl. No.: 19/102,296

(22) PCT Filed: Sep. 30, 2022
(86) PCT No.: PCT/CN2022/123028

§ 371 Date: Feb. 7, 2025

(51) Int. Cl. H04W 72/25; H04B 17/318

(52) U.S. Cl. CPC H04W 72/25; H04B 17/328

(57) ABSTRACT

Methods, systems, and devices for wireless communications at a first user equipment (UE) may be described. A user equipment (UE) may receive, from second and third UEs, first and second sidelink reservation messages that reserve at least first and second sidelink resources and indicate first and second starting transmission points for transmission of first and second messages. The UE may determine that the first and second sidelink resources overlap in time and frequency. The UE may transmit a conflict indication message to the second UE or the third UE based on a transmission conflict, the transmission conflict being identified based on the first and second starting transmission points and whether the second UE and the third UE may be hidden nodes to one another.

### CROSS REFERENCE

This application is a 371 National Stage of PCT Application No. PCT/CN2022/123028, filed on Sep. 30, 2022, entitled “SIDELINK CONFLICT DETERMINATION FOR HIDDEN NODES,” and assigned to the assignee hereof. The disclosure of the prior Application is considered part of and is incorporated by reference into this Patent Application.

### FIELD OF TECHNOLOGY

The following relates to wireless communications at a first user equipment (UE), including sidelink conflict determination for hidden nodes.

### BACKGROUND

Wireless communications systems may be widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may indicate a conflict between other wireless devices. However, such approaches may be improved.

### SUMMARY

The described techniques relate to improved methods, systems, devices, and apparatuses that support sidelink conflict determination for hidden nodes. For example, a user equipment (UE) may receive, from a second UE, a first sidelink reservation message that reserves at least a first sidelink resource in a shared sidelink channel, the first sidelink reservation message that may indicate a first starting transmission point for transmission of a first message in the first sidelink resource and a first priority of the first message. The UE may receive, from a third UE, a second sidelink reservation message that reserves at least a second sidelink resource in the shared sidelink channel, the second sidelink reservation message that may indicate a second starting transmission point for transmission of a second message in the second sidelink resource and a second priority of the second message. The UE may determine that the first sidelink resource and the second sidelink resource overlap in time and frequency. The UE may transmit a conflict indication message to the second UE or the third UE based on a transmission conflict, the transmission conflict being identified based on the first and second starting transmission points and whether the second UE and the third UE may be hidden nodes to one another.

A method for wireless communication by a first user equipment (UE) is described. The method may include receiving, from a second UE, a first sidelink reservation message that reserves at least a first sidelink resource in a shared sidelink channel, the first sidelink reservation message indicating a first starting transmission point for transmission of a first message in the first sidelink resource and a first priority of the first message, receiving, from a third UE, a second sidelink reservation message that reserves at least a second sidelink resource in the shared sidelink channel, the second sidelink reservation message indicating a second starting transmission point for transmission of a second message in the second sidelink resource and a second priority of the second message, determining that the first sidelink resource and the second sidelink resource overlap in time and frequency, and transmitting a conflict indication message to the second UE or the third UE based on a transmission conflict, the transmission conflict being identified based on the first and second starting transmission points and whether the second UE and the third UE are hidden nodes to one another.

An apparatus for wireless communication by a first UE is described. The apparatus may include a processor, memory coupled with the processor, and instructions stored in the memory. The instructions may be executable by the processor to cause the apparatus to receive, from a second UE, a first sidelink reservation message that reserves at least a first sidelink resource in a shared sidelink channel, the first sidelink reservation message indicating a first starting transmission point for transmission of a first message in the first sidelink resource and a first priority of the first message, receive, from a third UE, a second sidelink reservation message that reserves at least a second sidelink resource in the shared sidelink channel, the second sidelink reservation message indicating a second starting transmission point for transmission of a second message in the second sidelink resource and a second priority of the second message, determine that the first sidelink resource and the second sidelink resource overlap in time and frequency, and transmit a conflict indication message to the second UE or the third UE based on a transmission conflict, the transmission conflict being identified based on the first and second starting transmission points and whether the second UE and the third UE are hidden nodes to one another.

Another apparatus for wireless communication by a first UE is described. The apparatus may include means for receiving, from a second UE, a first sidelink reservation message that reserves at least a first sidelink resource in a shared sidelink channel, the first sidelink reservation message indicating a first starting transmission point for transmission of a first message in the first sidelink resource and a first priority of the first message, means for receiving, from a third UE, a second sidelink reservation message that reserves at least a second sidelink resource in the shared sidelink channel, the second sidelink reservation message indicating a second starting transmission point for transmission of a second message in the second sidelink resource and a second priority of the second message, means for determining that the first sidelink resource and the second sidelink resource overlap in time and frequency, and means for transmitting a conflict indication message to the second UE or the third UE based on a transmission conflict, the transmission conflict being identified based on the first and second starting transmission points and whether the second UE and the third UE are hidden nodes to one another.

A non-transitory computer-readable medium storing code for wireless communication by a first UE is described. The code may include instructions executable by a processor to receive, from a second UE, a first sidelink reservation message that reserves at least a first sidelink resource in a shared sidelink channel, the first sidelink reservation message indicating a first starting transmission point for transmission of a first message in the first sidelink resource and a first priority of the first message, receive, from a third UE, a second sidelink reservation message that reserves at least a second sidelink resource in the shared sidelink channel, the second sidelink reservation message indicating a second starting transmission point for transmission of a second message in the second sidelink resource and a second priority of the second message, determine that the first sidelink resource and the second sidelink resource overlap in time and frequency, and transmit a conflict indication message to the second UE or the third UE based on a transmission conflict, the transmission conflict being identified based on the first and second starting transmission points and whether the second UE and the third UE are hidden nodes to one another.

Some examples of the method, apparatuses, and non-transitory computer-readable medium described herein may further include operations, features, means, or instructions for receiving a first indication of a location of the second UE and a second indication of a location of the third UE and where whether the second UE and the third UE may be hidden nodes to one another may be based on a distance between the second UE and the third UE.

In some examples of the method, apparatuses, and non-transitory computer-readable medium described herein, the transmission conflict may be identified based on the distance between the second UE and the third UE satisfying a distance threshold and the first starting transmission point being the same as the second starting transmission point.

In some examples of the method, apparatuses, and non-transitory computer-readable medium described herein, the transmission conflict may be identified independent of the first and second starting transmission points based on the distance between the second UE and the third UE exceeding a distance threshold.

Some examples of the method, apparatuses, and non-transitory computer-readable medium described herein may further include operations, features, means, or instructions for receiving, from the second UE, a first list that indicates one or more UEs associated with one or more corresponding first received signal strength indicators calculated at the second UE that exceed a first received signal strength indicator threshold, receiving, from the third UE, a second list that indicates one or more UEs associated with one or more corresponding second received signal strength indicators calculated at the third UE that exceed a second received signal strength indicator threshold, and where whether the second UE and the third UE may be hidden nodes to one another may be based on the first list, the second list, or both.

In some examples of the method, apparatuses, and non-transitory computer-readable medium described herein, the transmission conflict may be identified based on the third UE being included in the first list, the second UE being included in the second list, or both and the first starting transmission point being the same as the second starting transmission point.

In some examples of the method, apparatuses, and non-transitory computer-readable medium described herein, the transmission conflict may be identified independent of the first and second starting transmission points based on the third UE not being included in the first list and the second UE not being included in the second list.

Some examples of the method, apparatuses, and non-transitory computer-readable medium described herein may further include operations, features, means, or instructions for receiving the first list and the second list via one or more broadcast transmissions, one or more groupcast transmissions, one or more unicast transmissions, or any combination thereof.

In some examples of the method, apparatuses, and non-transitory computer-readable medium described herein, whether the second UE and the third UE may be hidden nodes to one another may be based on whether a transmission conflict was detected between the second UE and the third UE during prior resources reserved by each of the second UE and the third UE.

In some examples of the method, apparatuses, and non-transitory computer-readable medium described herein, the transmission conflict may be identified based on not detecting a transmission conflict between the second UE and the third UE during a prior resource reserved by each of the second UE and the third UE and the first starting transmission point being the same as the second starting transmission point.

In some examples of the method, apparatuses, and non-transitory computer-readable medium described herein, the transmission conflict may be identified independent of the first and second starting transmission points based on detecting a transmission conflict between the second UE and the third UE during a prior resource reserved by each of the second UE and the third UE.

Some examples of the method, apparatuses, and non-transitory computer-readable medium described herein may further include operations, features, means, or instructions for receiving, from the second UE, first sidelink control information scheduling a first prior resource, receiving, from the third UE, second sidelink control information scheduling a second prior resource, where the first prior resource and the second prior resource overlap in time and frequency, and where detecting a transmission conflict may be based on a prior starting transmission point in the first prior resource and the second prior resource being different for each of the second UE and the third UE and a received signal power for the first sidelink control information, the second sidelink control information, or both, satisfying a threshold.

In some examples of the method, apparatuses, and non-transitory computer-readable medium described herein, the transmission conflict may be identified based on an absolute reference signal received power value for the first sidelink reservation message or the second sidelink reservation message satisfying a first reference signal received power threshold, or a differential reference signal received power value between the first sidelink reservation message and the second sidelink reservation message that satisfying a second reference signal received power threshold.

In some examples of the method, apparatuses, and non-transitory computer-readable medium described herein, the first starting transmission point and the second starting transmission point may be determined based on respective cyclic prefix extensions and the first starting transmission point being the same as the second starting transmission point may be based on the respective cyclic prefix extensions being of a same duration.

Some examples of the method, apparatuses, and non-transitory computer-readable medium described herein may further include operations, features, means, or instructions for receiving first sidelink control information indicating that hidden-node dependent conflict identification for the second UE may be enabled, receiving second sidelink control information indicating that hidden-node dependent conflict identification for the third UE may be enabled, and where the transmission conflict may be identified based on receiving the first sidelink control information and the second sidelink control information.

Some examples of the method, apparatuses, and non-transitory computer-readable medium described herein may further include operations, features, means, or instructions for receiving first sidelink control information from the second UE and second sidelink control information from the third UE, where at least one of the first sidelink control information and the second sidelink control information does not indicate activation of hidden-node dependent conflict identification and where the transmission conflict may be identified based on the first starting transmission point being a same point as the second starting transmission point.

Some examples of the method, apparatuses, and non-transitory computer-readable medium described herein may further include operations, features, means, or instructions for receiving first sidelink control information from the second UE and second sidelink control information from the third UE, where at least one of the first sidelink control information and the second sidelink control information does not indicate activation of hidden-node conflict identification and where the transmission conflict may be identified independent of the first starting transmission point and the second starting transmission point.

Some examples of the method, apparatuses, and non-transitory computer-readable medium described herein may further include operations, features, means, or instructions for receiving, from the second UE, first sidelink control information including a first zone identifier and a first communication range parameter, receiving, from the third UE, second sidelink control information including a second zone identifier and a second communication range parameter, and where the transmission conflict may be identified based on a distance between the second UE and the third UE determined using the first zone identifier, the first communication range parameter, the second zone identifier, the second communication range parameter, or any combination thereof.

In some examples of the method, apparatuses, and non-transitory computer-readable medium described herein, the first sidelink control information, the second sidelink control information, or both, include a zone identifier field and a communication range field.

In some examples of the method, apparatuses, and non-transitory computer-readable medium described herein, the first sidelink control information, the second sidelink control information, or both, may be third stage sidelink control information or may be of a dedicated sidelink control information format for conflict indication.

Some examples of the method, apparatuses, and non-transitory computer-readable medium described herein may further include operations, features, means, or instructions for receiving a location of the second UE, a location of the third UE, or both, via medium access control control element signaling.

### BRIEF DESCRIPTION OF THE DRAWINGS

FIG. 1 illustrates an example of a wireless communications system that supports sidelink conflict determination for hidden nodes in accordance with one or more examples as disclosed herein.

FIG. 2 illustrates an example of a wireless communications system that supports sidelink conflict determination for hidden nodes in accordance with one or more examples as disclosed herein.

FIG. 3 illustrates an example of a conflict indication scheme that supports sidelink conflict determination for hidden nodes in accordance with one or more examples as disclosed herein.

FIG. 4 illustrates an example of a process flow that supports sidelink conflict determination for hidden nodes in accordance with one or more examples as disclosed herein.

FIGS. 5 and 6 illustrate block diagrams of devices that support sidelink conflict determination for hidden nodes in accordance with one or more examples as disclosed herein.

FIG. 7 illustrates a block diagram of a communications manager that supports sidelink conflict determination for hidden nodes in accordance with one or more examples as disclosed herein.

FIG. 8 illustrates a diagram of a system including a device that supports sidelink conflict determination for hidden nodes in accordance with one or more examples as disclosed herein.

FIGS. 9 through 11 illustrate flowcharts showing methods that support sidelink conflict determination for hidden nodes in accordance with one or more examples as disclosed herein.

### DETAILED DESCRIPTION

In some sidelink communications scenarios, a first user equipment (UE) may indicate sidelink (SL) scheduling conflicts to a second UE or a third UE that may have both reserved overlapping resources for sidelink transmissions in unlicensed bands. The second UE and the third UE may employ the use of a listen-before-talk (LBT) mechanism in which a UE monitors a channel to assure that the channel may be clear before transmitting. The second UE and the third UE may also employ the use of a cyclic prefix extension (CPE) that may move a starting transmission point for transmissions for second and third UEs within a symbol period of a slot. In some instances, the second and third UEs may both use a same CPE or may use different CPEs. In situations in which the CPEs may be the same, collision may occur, and the first UE may engage in conflict indication. However, even in situations in which the CPEs may be different, if the second UE and third UE may be not aware of the presence of one another (e.g., may be hidden nodes to one another), collision may still occur (e.g., because, being hidden nodes to one another, they cannot resolve conflicts). For example, if the second UE uses a longer CPE than the third UE (thereby delaying the transmission by the second UE), the third UE may begin transmitting before the second UE. The second UE, in turn, may not transmit due to performing the LBT procedure in which the second UE detects that the third UE's transmission may be ongoing. However, if the second UE cannot hear the third UE's transmission (e.g., because, being hidden nodes to one another), the second UE may transmit on the overlapping resource even if the CPEs are different, resulting in undesired collisions.

To reduce or eliminate such transmission blockages, the first UE may engage in a hidden node or distance-based conflict determination process in which the first UE may indicate conflicts to the second or third UE that may be hidden nodes to one another. The first UE may determine a distance between the second and third UEs through different approaches, including absolute distance measurement or calculation, inclusion of the second or third UE on a list generated by the other of the second or third UE, or zone identifier indications. Further, the first UE may indicate conflicts based on one or more conditions, including resource overlapping, whether an absolute RSRP of a UE or a differential RSRP between two UEs exceeds an RSRP threshold, and whether CPEs for the two UEs may be different or the same. Such approaches for distance determination and conditions for triggering conflict indication may be included in a hidden node identification scheme that may be preconfigured for the first UE to enable the hidden node or distance-based conflict indication operations even outside the coverage area of a network entity. In some examples, the second UE, the third UE, or both may transmit sidelink control information (SCI) that may indicate the location of the second UE, the third UE, or both. Such SCI may be modified SCI signaling or may be dedicated SCI signaling for conflict identification.

In at least this way, conflicts may be avoided between the second UE and the third UE even though the second UE and the third UE may be hidden nodes to one another, offering increased communication speed and reliability for SL operations.

Aspects of the disclosure may be initially described in the context of wireless communications systems. Aspects of the disclosure may be then described with reference to a wireless communications system, a conflict indication scheme, and a process flow. Aspects of the disclosure may be further illustrated by and described with reference to apparatus diagrams, system diagrams, and flowcharts that relate to sidelink conflict determination for hidden nodes.

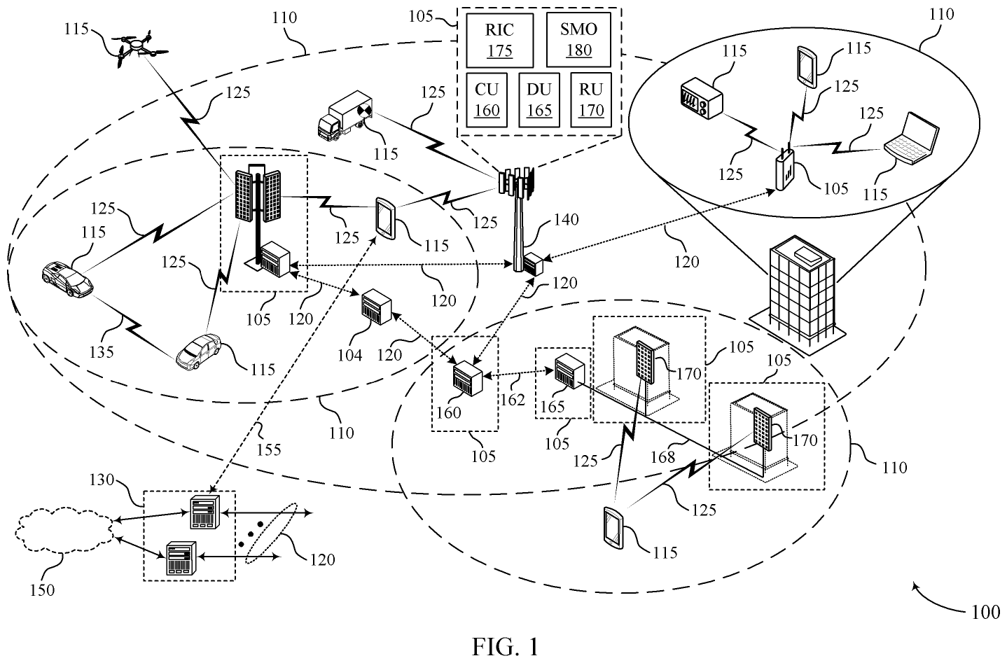

FIG. 1 illustrates an example of a wireless communications system 100 that supports sidelink conflict determination for hidden nodes in accordance with one or more examples as disclosed herein. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 may be illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 may be configured to receive information from a network entity 105 also discloses that a first node may be configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that may be physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that may be physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 may be flexible and may support different functionalities depending on which functions (e.g., network layer functions, protocol layer functions, baseband functions, RF functions, and any combinations thereof) may be performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer may be performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that may be in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That may be, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That may be, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That may be, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support sidelink conflict determination for hidden nodes as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that may be operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection may be anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Af) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that may be associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that may be performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz may be known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers may be transmitted to the same receiving device, and multiple-user MIMO (MU-MIMO), for which multiple spatial layers may be transmitted to multiple devices.

Beamforming, which may also be referred to as spatial filtering, directional transmission, or directional reception, may be a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that may indicate precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques may be described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to may have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data may be received successfully. Hybrid automatic repeat request (HARQ) feedback may be one technique for increasing the likelihood that data may be received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, a UE 115 may determine and indicate a transmission conflict between other wireless devices, such as other UEs 115, that may be hidden nodes to one another. For example, the UE 115 may receive scheduling from the other UEs that both attempt to reserve a same resource. However, because the other UEs may be hidden nodes to one another, they may not be aware of the presence of one another, leading to the scheduling conflict. As such, the UE 115 may determine the transmission conflict between the two other UEs and may transmit a conflict indication to the other UEs to inform them of the conflict and aid in resolution of the conflict. The UE 115 may employ one or more techniques for determining that the other UEs may be hidden nodes of one another, including determining a distance between the UEs, determining whether the other UEs appear on one another's lists of devices of which the other UEs may be aware, zone indications, other hidden node detection techniques (e.g., including other techniques described herein), or any combination thereof.

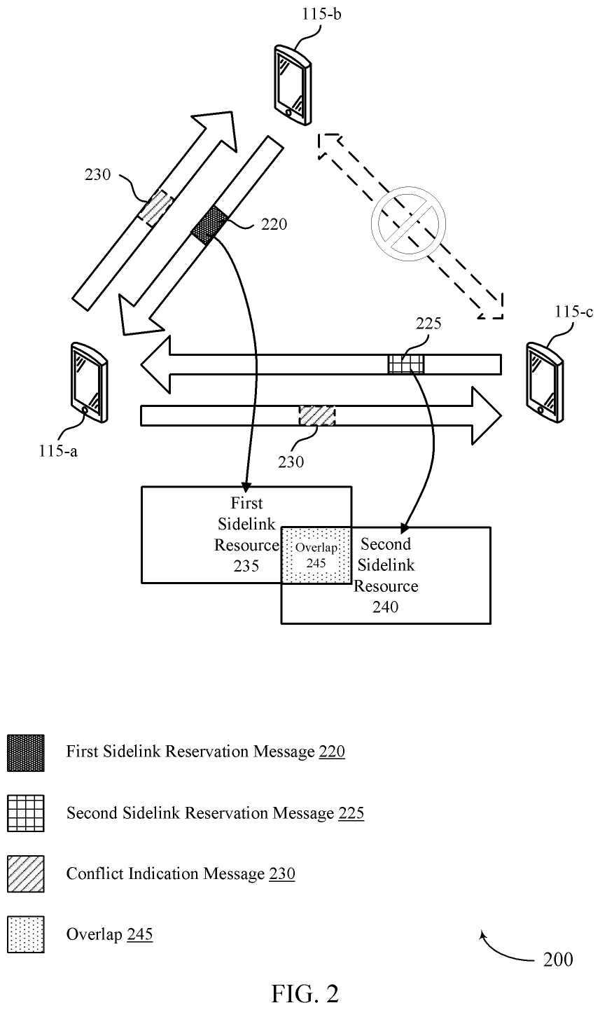

FIG. 2 illustrates an example of a wireless communications system 200 that supports sidelink conflict determination for hidden nodes in accordance with one or more examples as disclosed herein. The wireless communications system 200 may include a UE 115-a, a UE 115-b, and a UE 115-c. In some examples, the UE 115-a may be referred to as a first UE or a UE-A, the UE 115-b may be referred to as a second UE, and the UE 115-c may be referred to as a third UE. In some examples, the UE 115-b, the UE 115-c, or both, may be referred to as a UE-B.

In the course of wireless communications, UEs may communicate directly with one another via sidelink communications. However, in some situations, the UEs may schedule sidelink resources that may conflict. In such situations, a UE may transmit inter-UE coordination information about resource conflicts that one or more UEs that may have reserved conflicting resources may incorporate into respective resource selection or reselection procedures. For example, the UE 115-a may transmit inter-UE coordination information (e.g., the conflict indication message 230) about resource conflicts to the UE 115-b, UE 115-c or both, that the UE 115-b, UE 115-c, or both may incorporate intro respective resource selection or reselection procedures. The UE 115-a may indicated one or more expected resource conflicts with resources reserved (e.g., the first sidelink resource 235, the second sidelink resource 240, or both) by UE 115-b, UE 115-c, or both. In some cases, the UE 115-a may be a recipient of at least one transport block that includes a conflicting reservation. In some examples, whether the non-destination UE of a transport block transmitted by UE 115-b or UE 115-c may be the UE 115-a may be configured through control signaling (e.g., RRC signaling, optionally including one or more parameters such as sl-Type (JE-A).

A conflict detected, determined, or indicated by the UE 115-a may include an overlap between resources reserved by the UE 115-b, the UE 115-c, one or more other UEs, or any combination thereof. For example, the first sidelink reservation message 220 may indicate a reservation of the first sidelink resource 235 by the UE 115-b, the second sidelink reservation message 225 may indicate a reservation of the second sidelink resource 240 by the UE 115-c, and the first sidelink resource 235 and the second sidelink resource 240 may overlap (e.g., as shown by the overlap 245). Additionally, or alternatively, an overlap may be determined (e.g., by the UE 115-a) when the UE 115-a may have a half-duplex conflict in a slot in which the UE 115-b, the UE 115-c, or both may be transmitting a message to the UE 115-a.

In some examples, one or more conditions may apply for determining a conflict. For example, a conflict on the overlap 245 may be determined when a reference signal received power (RSRP) of a transmission (e.g., the first sidelink reservation message 220 or the second sidelink reservation message 225) satisfies (e.g., meets or exceeds) a threshold. For example, if the UE 115-a may be an intended receiver for a physical sidelink shared channel (PSSCH) transmission in a reserved resource of UE 115-b or UE 115-c, the UE 115-a may determine a resource conflict if the RSRP of the other UE, i.e, UE 115-c or UE 115-b may be above a threshold (e.g., a threshold associated with one or more priorities associated with the transmissions of the UE 115-b, the UE 115-c, or both). In some examples, such a threshold (optionally associated with the one or more priorities associated with the transmissions of the UE 115-b, the UE 115-c, or both) may be configured by control signaling (e.g., RRC signaling).

Additionally, or alternatively, a differential RSRP measurement may be made (e.g., between the first sidelink reservation message 220 and the second sidelink reservation message 225) and a conflict may be determined based on such a measurement (e.g., whether the differential RSRP satisfies (e.g., meets or exceeds) a threshold). In some examples, control signaling (e.g., RRC signaling may indicate which condition may be applied for conflict determination). For example, if the UE 115-a may be an intended receiver for a PSSCH transmission in a reserved resource of the UE 115-b, the UE 115-a may determine a resource conflict if an RSRP of a transmission from the UE 115-c (e.g., the second sidelink reservation message 220) may be greater than or equal to the sum of an RSRP of a transmission from the UE 115-b (e.g., the first sidelink reservation message 225) and a threshold (e.g., expressed by a parameter such as Delta_Th). Additionally, or alternatively, if the UE 115-a may be an intended receiver for a PSSCH transmission in a reserved resource of the UE 115-c, the UE 115-a may determine a resource conflict if an RSRP of a transmission from the UE 115-b (e.g., the first sidelink reservation message 225) may be greater than or equal to the sum of an RSRP of a transmission from the UE 115-c (e.g., the second sidelink reservation message 220) and a threshold (e.g., expressed by a parameter such as Delta_Th). In some examples, such a threshold may be configured by control signaling (e.g., RRC signaling).

In some examples, an ability of the UE 115-b, the UE 115-c, or both may be signaled in sidelink control information (SCI). In some examples, a UE with such an ability may be referred to as the UE-B. Such a UE may be a UE that may have scheduled a lower priority transmission (e.g., relative to another transmission of another UE) and may indicate the ability to receive conflict indicators (e.g., the conflict indication message 230). For example, (assuming the UE 115-b may have indicated such an ability and receives the conflict indication message 230), the UE 115-b may, in response to receiving the conflict indication message 230, determine a presence of a resource conflict based on conflict information in a physical sidelink feedback channel (PSFCH) reception (e.g., the conflict indication message 230), the UE 115-b may report the resource conflict to higher layers based on one or more conditions. For example, if an exclusion scheme parameter (e.g., slotlevelResourceExclusionScheme2) may be not provided, the UE 115-b may report that resources overlapping with a next in time reserved resource indicated using a control signaling format (e.g., SCI format 1-A, optionally associated with time-frequency resource collision). Additionally, or alternatively, if an exclusion scheme parameter (e.g., slotLevelResource ExclusionScheme2) may be provided, the UE 115-b may report resources in a slot of a next in time reserved resource indicated using a control signaling format (e.g., SCI format 1-A, optionally associated with half-duplex communications). In some examples, a MAC layer (or other element) at the UE 115-b may select the reported resources from the resources indicated by a PHY layer excluding the reported resources.

In some examples, a conflict determination scheme based on a cyclic prefix extension (CPE) may be employed. For example, if conflicting resources (e.g., the first sidelink resource 235 and the second sidelink resource 240) may be associated with the same CPE (e.g., a CPE of a same duration), the UE 115-a may determine that a resource conflict occurs and transmit conflict indication (e.g., the conflict indication message 230) to the UE 115-b, the UE 115-c, or both, while if the conflict resources may be associated with different CPEs (e.g., CPEs of different durations), the UE 115-a may determine that no resource conflict exists and may not transmit a conflict indication (e.g., the conflict indication message 230) to the UE 115-b, the UE 115-c, or both. If the conflict resources may be associated with different CPEs (e.g., of different durations), even if the UE 115-a does not transmit conflict indication to UE 115-b, UE 115-c, or both, the transmission in the resource with a first CPE (e.g., with an earlier starting point) may block the transmission in the resource with a second CPE (e.g., with a later starting point) due to an LBT requirement in unlicensed band. For example, the device transmitting with a second CPE may monitor (e.g., “listen” to) the channel in the unlicensed band in which the device may be to transmit before transmitting (e.g., “talking”) and may receive the transmission associated with the first CPE and may not transmit the transmission associated with the second CPE (e.g., based on the monitoring, receiving the transmission associated with the first CPE, or both).

However, if the UE 115-b that may indicate the first sidelink resource 235 and the UE 115-c that may indicate the second sidelink resource 240 may be hidden nodes of one another, an LBT operation may not detect any competing transmissions, and both UEs may attempt to transmit and conflict may still occur, despite the use of CPEs of different durations (e.g., and therefore different transmission starting points). Thus, a conflict determination scheme (e.g., including one or more techniques described herein) may involve transmitting the conflict indication message 230 to the UE 115-b and the UE 115-c that may be hidden nodes to one another. Such schemes may employ a hidden node or distance-based conflict determination for sidelink operations.

For example, the UE 115-a may receive, from the UE 115-b, the first sidelink reservation message 220 that reserves the first sidelink resource 235. The first sidelink reservation message 220 may indicate a first starting transmission point for transmission of a first message in the first sidelink resource 235 and a first priority of the first message. The UE 115-a may receive, from the UE 115-c, the second sidelink reservation message 225 that reserves the second sidelink resource 240. The second sidelink reservation message 225 may indicate a second starting transmission point for transmission of a second message in the second sidelink resource and a second priority of the second message. The UE 115-a may determine that the first sidelink resource 235 and the second sidelink resource 240 at least partially overlap (e.g., in time, frequency, space, or any combination thereof). The UE may transmit a conflict indication message 230 to the UE 115-b, the UE 115-c, or both, based on a transmission conflict. The UE 115-a may identify or determine the transmission conflict based on the first and second starting transmission points, whether the UE 115-b and the UE 115-c may be hidden nodes to one another, one or more other factors (e.g., as described herein), or any combination thereof. In at least these ways, the UE 115-a may indicate conflicts to the UE 115-b, the UE 115-c, or both, even though the UE 115-b and the UE 115-c may be hidden nodes to one another, thus avoiding transmission conflicts or blockages, increasing speed, reliability, throughput, and other characteristics of the wireless communications system 200.

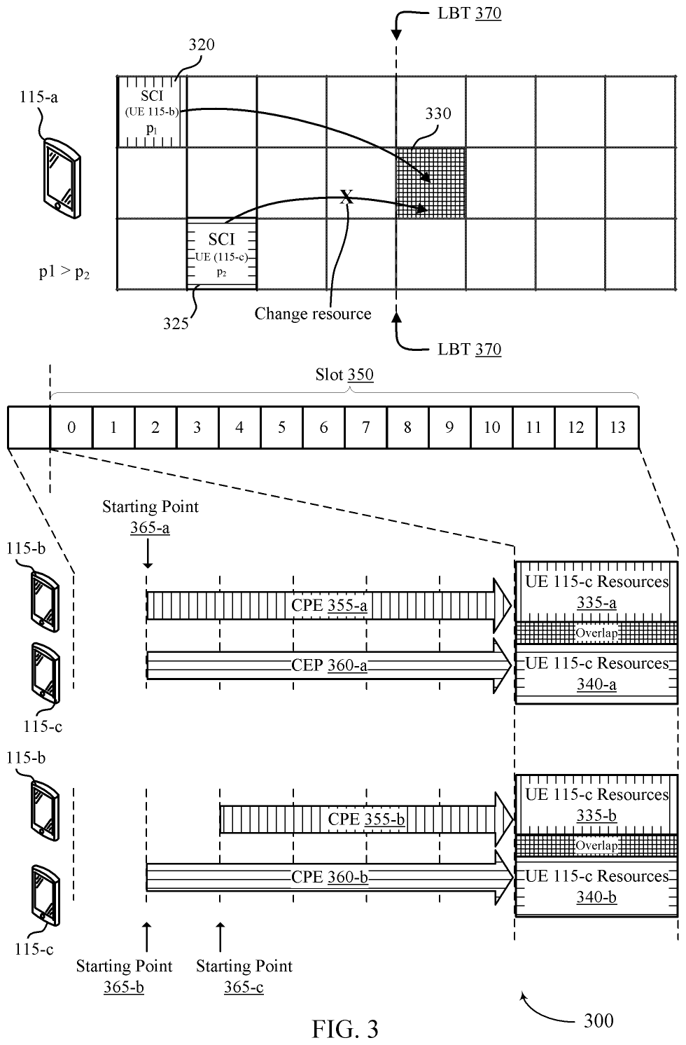

FIG. 3 illustrates an example of a conflict indication scheme 300 that supports sidelink conflict determination for hidden nodes in accordance with one or more examples as disclosed herein. The conflict indication scheme 300 may include or involve the UE 115-a, the UE 115-b, and the UE 115-c, and may involve resolution of a conflict occurring in a common resource 330 in slot 350.

As described herein, conflict determination may be based on a different CPEs 355 (e.g., CPEs 355 of different durations). For example, the UE 115-b and the UE 115-c may schedule resources (e.g., via SCI 320 and SCI 325, respectively) that overlap (e.g., at least partially occurring in the common resource 330). In some examples, the UE 115-b resources 335-a and the UE 115-c resources 340-a may be associated with first CPE 355-a and second CPE 360-a, respectively, and the first CPE 355-a and the second CPE 360-a may be of a same duration. Additionally, or alternatively, the UE 115-b resources 335-b and the UE 115-c resources 340-b may be associated with first CPE 355-b and second CPE 360-b, respectively, and the first CPE 355-b and the second CPE 360-b may be of different durations. As described herein if the conflict resources may be associated with different CPEs, even if the UE 115-a doesn't transmit conflict indication to UE 115-b, UE 115-c, or both, the transmission in the resource with second CPE 360-b (e.g., with an earlier starting point) may block the transmission in the resource with first CPE 355-b (e.g., with a later starting point) due to the LBT 370 operation being performed (e.g., by UE 115-b in the depicted example) in an unlicensed band. Thus, the UE 115-a may transmit a conflict indication to the UE 115-b, the UE 115-c, or both, to indicate the conflict, only when the first CPE 355-a and the second CPE 360-a may be of same durations and the UE 115-b resources 335-b and the UE 115-c resources 340-b may be associated with same transmission starting point.

As depicted in the example of FIG. 3, the UE 115-a may receive SCI 320 from the UE 115-b that may be associated with a first transmission of a first priority p₁ and the SCI 320 may reserve the UE 115-b resources 335 (e.g., that may be at least partially located in the common resource 330, or may be within a same slot). The UE 115-a may also receive SCI 325 from the UE 115-c that may reserve the UE 115-c resources 335 (e.g., that may be at least partially located in the common resource 330).

In some examples, the UE 115-a may determine whether a resource conflict occurs or not based on the distance between the UE 115-b and the UE 115-c. In a first example case of distance determination, the UE 115-a may determine that the location of UE 115-b may be (x1, y1), the location of UE 115-c may be (x2, y2), and a distance between the UE 115-b and the UE 115-c. The UE 115-a may further determine that such a distance does or does not satisfy (e.g. does or does not meet or exceed) a distance threshold. Such determinations may be used to determine whether the UE 115-b and the UE 115-c are hidden nodes to one another. For example, UE 115-a may determine (e.g., based on the distance between the UE 115-b and the UE 115-c being smaller than or not satisfying the threshold) that the UE 115-b and the UE 115-c are not hidden nodes to one another (e.g., because the distance between them is small enough that they UE 115-b and the UE 115-c may communicate). Additionally, or alternatively, the UE 115-a may determine that the UE 115-b and the UE 115-c are hidden nodes from one another based on the distance between them (e.g., if the distance satisfies or exceeds the distance threshold).

However, the determination of hidden nodes may not be exclusively linked to a distance between the UE 115-b and the UE 115-c satisfying or not satisfying a distance threshold. Even if the distance is less than the threshold, the UE 115-b and the UE 115-c may still be hidden nodes from one another. Conversely, even if the distance is greater than the threshold, the UE 115-b and the UE 115-c are not necessarily hidden nodes to one another. The UE 115-a may engage in various techniques to determine whether the UE 115-b and the UE 115-c are hidden nodes.

In some examples, the UE 115-a may determine that the distance between the UE 115-b and the UE 115-c does not satisfy or is not larger than the distance threshold and the UE 115-a may determine that a resource conflict occurs if one or more conditions are satisfied (e.g., including if all of the conditions are satisfied). A first condition may be that the UE 115-b resources 335 and the UE 115-c resources 340 overlap at least partially in time, frequency, or both. A second condition may be that an absolute RSRP of the SCI 320, the SCI 325, or both, satisfies an absolute RSRP threshold (e.g., as described herein). Additionally, or alternatively, the second condition may be that a differential RSRP of the SCI 320 and the SCI 325 (e.g., a difference between the SCI 320 and the SCI 325) satisfies a differential RSRP threshold (e.g., as described herein). As described herein, such a threshold may be preconfigured or may be configured by control signaling (e.g., RRC signaling). A third condition may be that the CPE 355-a associated with the UE 115-b resources 335-a may be of a same duration as the CPE 360-a associated with the UE 115-c resources 340. In such a case, transmissions from the UE 115-b and the UE 115-c may both be associated with starting point 365-a.

For example, if the distance between the UE 115-b and the UE 115-c may be not larger than a threshold, but the CPE 355 associated with the UE 115-b may be different from the second CPE 360 associated with the UE 115-c (e.g., the CPE 355-b and the CPE 360-b) resulting in transmissions from the UE 115-b and the UE 115-c being associated with different starting points (e.g., starting point 365-c and starting point 365-b, respectively), the UE 115-a may not transmit the conflict indication to the UE 115-c. This may be because the distance between these two UEs may be close and the conflict may be avoided by simply by the different starting points.

In a second example case of distance determination, the UE 115-a may determine that the location of UE 115-b may be (x1, y1), the location of UE 115-c may be (x2, y2), and that the distance between the UE 115-b and the UE 115-c may be larger than the threshold. In such a case, the UE may determine that the UE 115-b and the UE 115-c are hidden nodes from one another (e.g., because the distance between them is large enough that they may not communicate directly with one another). Further, the UE may determine that a resource conflict occurs based on existing conditions. For example, the UE 115-a may determine that a resource conflict occurs if one or more conditions may be met, regardless of any durations of CPEs or of any starting points 365. A first condition may be that the UE 115-b resources 335 and the UE 115-c resources 340 overlap. A second condition may be that an absolute RSRP of the SCI 320, the SCI 325, or both, satisfies an absolute RSRP threshold (e.g., as described herein). Additionally, or alternatively, the second condition may be that a differential RSRP of the SCI 320 and the SCI 325 (e.g., a difference between the SCI 320 and the SCI 325) satisfies a differential RSRP threshold (e.g., as described herein). As described herein, such a threshold may be preconfigured or may be configured by control signaling (e.g., RRC signaling).

In some examples, the UE 115-a may determine whether a resource conflict occurs or not based on UE lists from the UE 115-b and the UE 115-c (e.g., lists of UEs of which the UE generating the list may be aware or with which the UE generating the list may have communicated). For example, a UE list may include UEs transmitting signals of which a received signal strength indication (RSSI) satisfies (e.g., meets or exceeds) a threshold. Such a threshold may be a fixed or preconfigured value, or may be configured through control signaling (e.g., RRC signaling). In some examples, the UE 115-a may determine, based on the presence or lack of a UE appearing in the list of another UE, that the UEs are or are not hidden nodes to one another. For example, the UE 115-a may determine that the UE 115-b does not appear in the list generated by UE 115-c, the UE 115-c does not appear in the list generated by UE 115-b, and that the UE 115-b and the UE 115-c are hidden nodes to one another based on not appearing in one another's lists. Similarly, if the UE 115-b does appear in the list generated by the UE 115-c or the UE 115-c does appear in the list generated by the UE 115-b, then the UE 115-a may determine that the UE 115-b and the UE 115-c are not hidden nodes to one another.

However, the determination of hidden nodes may not be exclusively linked to the UE 115-b or the UE 115-c appearing or not appearing in one or more UE lists. The UE 115-a may engage in various techniques to determine whether the UE 115-b and the UE 115-c are hidden nodes.

In one example, if the UE 115-c appears in a UE list generated by the UE 115-b or the UE 115-b appears in such a list generated by the UE 115-c or both, then the UE 115-a may determine that a resource conflict occurs if one or more conditions are satisfied (e.g., including if all of the conditions are satisfied). A first condition may be that the UE 115-b resources 335 and the UE 115-c resources 340 overlap. A second condition may be that an absolute RSRP of the SCI 320, the SCI 325, or both, satisfies an absolute RSRP threshold (e.g., as described herein). Additionally, or alternatively, the second condition may be that a differential RSRP of the SCI 320 and the SCI 325 (e.g., a difference between the SCI 320 an the SCI 325) satisfies a differential RSRP threshold (e.g., as described herein). As described herein, such a threshold may be preconfigured or may be configured by control signaling (e.g., RRC signaling). A third condition may be that the CPE 355-a associated with the UE 115-b resources 335-a may be of a same duration as the CPE 360-a associated with the UE 115-c resources 340. In such a case, transmissions from the UE 115-b and the UE 115-c may both be associated with starting point 365-a.

Additionally, or alternatively, if the UE 115-c does not appear in a UE list generated by the UE 115-b and the UE 115-b does not appear in a UE list generated by the UE 115-c, the UE may determine whether a resource conflict occurs based on one or more existing conditions. For example, the UE 115-a may determine that a resource conflict occurs if one or more conditions may be met, regardless of any durations of CPEs or of any starting points 365. A first condition may be that the UE 115-b resources 335 and the UE 115-c resources 340 overlap. A second condition may be that an absolute RSRP of the SCI 320, the SCI 325, or both, satisfies an absolute RSRP threshold (e.g., as described herein). Additionally, or alternatively, the second condition may be that a differential RSRP of the SCI 320 and the SCI 325 (e.g., a difference between the SCI 320 and the SCI 325) satisfies a differential RSRP threshold (e.g., as described herein). As described herein, such a threshold may be preconfigured or may be configured by control signaling (e.g., RRC signaling).

In some examples, the UE 115-a may obtain UE lists from the UE 115-b and the UE 115-c. For example, a UE that may be to generate a list, such as the UE 115-b, may measure, determine, or otherwise obtain RSSIs of transmissions from other UEs and store an identifier of each UE for which a respective RSSI satisfies an RSSI threshold (e.g., a preconfigured RSSI threshold or an RSSI threshold configured via control signaling, such as RRC signaling). The UE that may be to generate a list may transmit to the list to one or more other devices (e.g., other UEs) through broadcast, groupcast, or unicast.

In some examples, the UE 115-a may determine whether a resource conflict occurs or not based on whether the UE 115-a may have detected collisions for previous reserved resources from the UE 115-b and the UE 115-c. For example, if the UE 115-a may have not detected collisions for previous reserved resources from the UE 115-b and the UE 115-c, the UE 115-a may determine that a resource conflict occurs if one or more conditions are satisfied (e.g., including if all of the conditions are satisfied). A first condition may be that the UE 115-b resources 335 and the UE 115-c resources 340 overlap. A second condition may be that an absolute RSRP of the SCI 320, the SCI 325, or both, satisfies an absolute RSRP threshold (e.g., as described herein). Additionally, or alternatively, the second condition may be that a differential RSRP of the SCI 320 and the SCI 325 (e.g., a difference between the SCI 320 and the SCI 325) satisfies a differential RSRP threshold (e.g., as described herein). As described herein, such a threshold may be preconfigured or may be configured by control signaling (e.g., RRC signaling). A third condition may be that the CPE 355-a associated with the UE 115-b resources 335-a may be of a same duration as the CPE 360-a associated with the UE 115-c resources 340. In such a case, transmissions from the UE 115-b and the UE 115-c may both be associated with starting point 365-a.

If, however, the UE 115-a may have detected collisions for previous reserved resources from the UE 115-b and the UE 115-c, the UE may determine whether a resource conflict occurs based on one or more existing conditions. For example, the UE 115-a may determine that a resource conflict occurs if one or more conditions may be met, regardless of any durations of CPEs or of any starting points 365. A first condition may be that the UE 115-b resources 335 and the UE 115-c resources 340 overlap. A second condition may be that an absolute RSRP of the SCI 320, the SCI 325, or both, satisfies an absolute RSRP threshold (e.g., as described herein). Additionally, or alternatively, the second condition may be that a differential RSRP of the SCI 320 and the SCI 325 (e.g., a difference between the SCI 320 and the SCI 325) satisfies a differential RSRP threshold (e.g., as described herein). As described herein, such a threshold may be preconfigured or may be configured by control signaling (e.g., RRC signaling).

In some examples, the UE 115-a may determine whether the UE 115-a may have detected collisions for previously reserved resources from the UE 115-b and the UE 115-c using one or more techniques. In a first technique, if the UE 115-a detects a first SCI scheduling a first PSSCH transmission in a first previous reserved resource from the UE 115-b and the UE 115-a detects a second SCI scheduling a second PSSCH transmission in a second previous reserved resource from the UE 115-c, the UE 115-a may determine that a collision was detected for the first previous reserved resource and the second previous reserved resource if one or more conditions are satisfied (e.g., including if all of the conditions are satisfied). A first condition may be that the first previous reserved resource and the second previous reserved resource overlap. A second condition may be that the first previous reserved resource and the second previous reserved resource be associated with different CPEs (e.g., CPEs of different durations). A third condition may be that that an absolute RSRP projected to the first previous received resource, the second previous received resource, or both, satisfy an absolute RSRP threshold (e.g., as described herein). Additionally, or alternatively, the second condition may be that a differential RSRP projected to the first previous received resource and the second previous received resource (e.g., a difference between the first SCI, the second SCI, or both) satisfies a differential RSRP threshold (e.g., as described herein). Such a threshold may be preconfigured or may be configured by control signaling (e.g., RRC signaling)

A third condition may be that an absolute RSRP of the first SCI, the second SCI, or both, satisfy an absolute RSRP threshold (e.g., as described herein). Additionally, or alternatively, the second condition may be that a differential RSRP of the first SCI, the second SCI, or both (e.g., a difference between the first SCI, the second SCI, or both) satisfies a differential RSRP threshold (e.g., as described herein). Such a threshold may be preconfigured or may be configured by control signaling (e.g., RRC signaling).

In some examples, hidden node-based conflict determination and indication may not be employed. Additionally, or alternatively, conflict indication may involve a determination of whether there may be one or more hidden nodes around a UE that may transmit potentially conflicting transmissions. As such, it may be beneficial to support dynamic indication of hidden node-based conflict determination and indication.

In a first example, if a transmitting UE (e.g., the UE 115-b or the UE 115-c) may indicate that an inter-UE coordination scheme may be enabled (e.g., in SCI), the transmitting UE may further indicate whether hidden node-based conflict indication may be enabled or not. In some examples, a reserved bit in SCI (e.g., SCI-1 ) or a reserved value in an existing field may be employed for such an indication. In such a case, if hidden node-based conflict indication may be enabled in both a first SCI (e.g., the SCI 320, which may be an SCI-1 ) for the first reserved resource (e.g., UE 115-b resources 335) and the second SCI (e.g., the SCI 325, which may be an SCI-1 ) for the second reserved resource (e.g., UE 115-c resources 340), the UE 115-a may determine a resource conflict using one or more techniques described herein.

However, if hidden node-based conflict indication may be not indicated or may be disabled in SCI (e.g., an SCI-1), the UE 115-a may determine whether a resource conflict exists using one or more of the following techniques or combinations of elements of one or more of the following techniques. In a first technique (e.g., as a default behavior), the UE 115-a may indicate a conflict regardless of any CPE length (or starting points) associated with potentially conflicting resources. In a second technique (e.g., as a default behavior), the UE 115-a may indicate a conflict if durations of CPEs (or starting points) associated with the potentially conflicting resources may be the same. In such a technique, it may be assumed that the UE 115-a may be capable of knowing whether one or more devices may be hidden nodes to one another. Therefore, if the UE 115-b or UE 115-c does not enable hidden node-based conflict indication, it may imply a lack of one or more hidden nodes.

In some examples, to support hidden node or distance-based conflict determination and indication, UE 115-a may use the location of the UE 115-b and the UE 115-c. In some examples, such locations may be calculated based on a zone identifier, a communication range requirement (e.g., in SCI-2), or both. However, in some approaches, zone ID and communication range requirements may not be included for groupcast in situations where NACK-only feedback may be not selected. As such, an updated zone ID and communication range requirements scheme may be employed.

In some examples, one or more modifications to SCI may be employed. For example, one or more fields for a zone identifier, communication range requirement, or both may be included in SCI (e.g., in SCI-2A or SCI-2C). In some such examples, one or more of these fields may be present or activated if hidden node or distance-based conflict determination may be configured by control signaling (e.g., RRC signaling). Additionally, or alternatively, one or more of these fields may be present or activated if hidden node-based or distance-based conflict determination may be indicated in SCI (e.g., SCI-1 ).

In some examples, a third-stage SCI may be used for hidden node or distance-based conflict determination in which one or more fields for a zone identifier, a communication range requirement, or both may be included in the 3rd stage SCI. Additionally, or alternatively, if hidden node-based or distance-based conflict indication may be enabled in SCI (e.g., SCI-1 ) and a second stage SCI format may be not of a first format (e.g., SCI-2B), the third stage SCI may be transmitted. Otherwise, third stage SCI may not transmitted.

In some examples, a SCI format for hidden node or distance-based conflict determination (e.g., a format dedicated for the use of hidden node or distance-based conflict determination) may be employed in situations in which hidden node or distance-based conflict determination may be enabled. Such an SCI format may include one or more fields for at least the zone identifier, the communication range requirement, or both.

In some examples, the UE may use one or more received zone identifiers, one or more communication range requirements, or any combination thereof, to determine whether one or more UEs are hidden nodes from one another. For example, if the UE 115-b and the UE 115-c transmit zone identifiers or communication range requirements to the UE 115-a, the UE 115-a may determine whether the UE 115-b and the UE 115-c are hidden nodes from one another based on the received zone identifiers, communication range requirements, or both.

In some examples, location information of a transmitting UE (e.g., the UE 115-b or UE 115-c) may be included in control signaling, such as MAC control element (MAC-CE) signaling. Including the location information may be helpful if the UE 115-a may be to receive the transmission from the transmitting UE (e.g., the UE 115-b or the UE 115-c). In such a case, location information may be more accurate or detailed than other location information provided in other techniques or in other approaches.

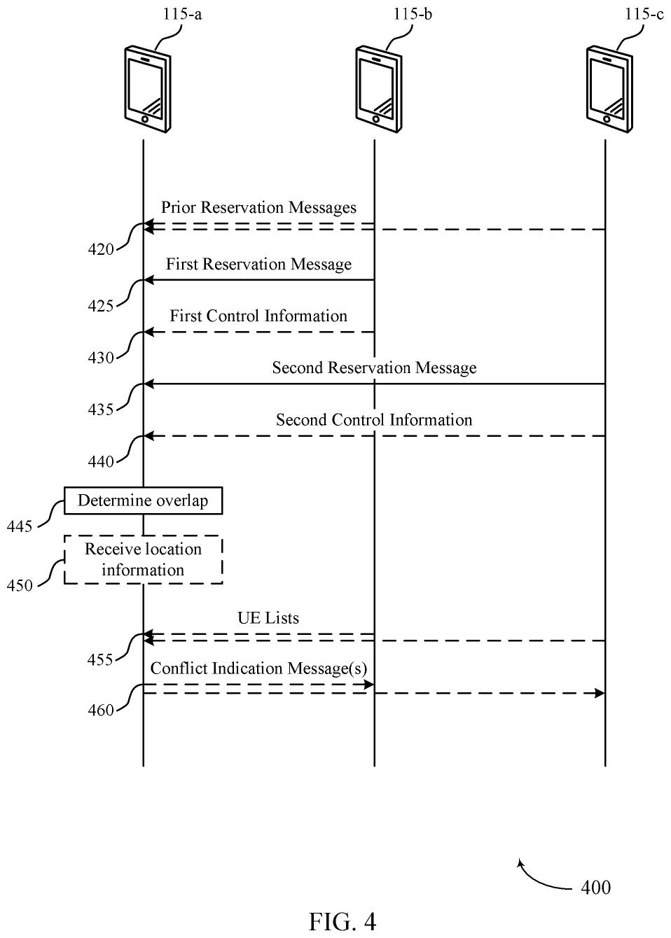

FIG. 4 illustrates an example of a process flow 400 that supports sidelink conflict determination for hidden nodes in accordance with one or more examples as disclosed herein. The process flow 400 may implement various aspects of the present disclosure described herein. The elements described in the process flow 400 may be examples of similarly-named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the UE 115-a may receive, from the UE 115-b, first sidelink control information scheduling a first prior reserved resource. Further, the UE 115-a may receive, from the UE 115-c, second sidelink control information scheduling a second prior resource. In some examples, the first prior reserved resource and the second prior reserved resource may overlap in time and frequency. In some examples, the first starting transmission point and the second starting transmission point may be determined based on respective cyclic prefix extensions. In some examples, the first starting transmission point being the same as the second starting transmission point may be based on the respective cyclic prefix extensions being of a same duration.

At 425, the UE 115-a may receive, from a UE 115-b, a first sidelink reservation message that reserves at least a first sidelink resource in a shared sidelink channel, the first sidelink reservation message that may indicate a first starting transmission point for transmission of a first message in the first sidelink resource and a first priority of the first message. In some examples, the first starting transmission point and the second starting transmission point may be determined based on respective cyclic prefix extensions. In some examples, the first starting transmission point being the same as the second starting transmission point may be based on the respective cyclic prefix extensions being of a same duration.

At 430, the UE 115-a may receive first sidelink control information that may indicate that hidden-node dependent conflict identification for the UE 115-b is enabled. In some example, the hidden-node dependent conflict identification may be indicated in the first reservation message for the UE-115b although this is not shown in the figure.

In some examples, the first sidelink control information may include a first zone identifier and a first communication range parameter. In some examples, the first sidelink control information, the second sidelink control information, or both, comprise a zone identifier field and a communication range field. In some examples, the first sidelink control information, the second sidelink control information, or both, may be third stage sidelink control information or may be of a dedicated sidelink control information format for conflict indication. In some examples, the first sidelink control information, the second sidelink control information, or both, may be third stage sidelink control information or may be of a dedicated sidelink control information format for conflict indication.

At 435, the UE 115-a may receive, from a UE 115-c, a second sidelink reservation message that reserves at least a second sidelink resource in the shared sidelink channel, the second sidelink reservation message that may indicate a second starting transmission point for transmission of a second message in the second sidelink resource and a second priority of the second message. In some examples, the first starting transmission point and the second starting transmission point may be determined based on respective cyclic prefix extensions. In some examples, the first starting transmission point being the same as the second starting transmission point may be based on the respective cyclic prefix extensions being of a same duration.

At 440, the UE 115-a may receive second sidelink control information that may indicate that hidden-node dependent conflict identification for the UE 115-c is enabled. In some example, the hidden-node dependent conflict identification may be indicated in the second reservation message for the UE-115c although this is not shown in the figure.

In some examples, the second sidelink control information may include a second zone identifier and a second communication range parameter. In some examples, the first sidelink control information, the second sidelink control information, or both, comprise a zone identifier field and a communication range field. In some examples, the first sidelink control information, the second sidelink control information, or both, may be third stage sidelink control information or may be of a dedicated sidelink control information format for conflict indication. In some examples, the first sidelink control information, the second sidelink control information, or both, may be third stage sidelink control information or may be of a dedicated sidelink control information format for conflict indication.

At 445, the UE 115-a may determine that the first sidelink resource and the second sidelink resource overlap in time and frequency.

At 450, the UE 115-a may receive a first indication of a location of the UE 115-b and a second indication of a location of the UE 115-c. In some examples, the UE 115-a may receive a location of the UE 115-b, a location of the UE 115-c, or both, via medium access control control element signaling

At 455, the UE 115-a may receive, from the UE 115-b, a first list that may indicate one or more UEs associated with one or more corresponding first received signal strength indicators calculated at the UE 115-b that exceed a first received signal strength indicator threshold. The UE 115-a may further receive, from the UE 115-c, a second list that may indicate one or more UEs associated with one or more corresponding second received signal strength indicators calculated at the UE 115-c that exceed a second received signal strength indicator threshold. In some examples, the UE 115-a may receive the first list and the second list via one or more broadcast transmissions, one or more groupcast transmissions, one or more unicast transmissions, or any combination thereof.

At 460, the UE 115-a may transmit a conflict indication message to the UE 115-b or the UE 115-c based on a transmission conflict, the transmission conflict being identified based on the first and second starting transmission points and whether the UE 115-b and the UE 115-c are hidden nodes to one another. In some examples, whether the UE 115-b and the UE 115-c are hidden nodes to one another may be based on a distance between the UE 115-b and the UE 115-c. In some examples, the transmission conflict may be identified based on the distance between the UE 115-b and the UE 115-c satisfying a distance threshold and the first starting transmission point being the same as the second starting transmission point.

In some examples, the transmission conflict may be identified independent of the first and second starting transmission points based on the distance between the UE 115-b and the UE 115-c exceeding a distance threshold.

In some examples, whether the UE 115-b and the UE 115-c are hidden nodes to one another may be based on the first list, the second list, or both. In some examples, the transmission conflict may be identified based on the UE 115-c being included in the first list, the UE 115-b being included in the second list, or both and the first starting transmission point being the same as the second starting transmission point. In some examples, the transmission conflict may be identified independent of the first and second starting transmission points based on the UE 115-c not being included in the first list and the UE 115-b not being included in the second list.

In some examples, whether the UE 115-b and the UE 115-c are hidden nodes to one another may be based on whether a transmission conflict was detected between the UE 115-b and the UE 115-c during prior resources reserved by each of the UE 115-b and the UE 115-c. In some examples, the transmission conflict may be identified based on not detecting a transmission conflict between the UE 115-b and the UE 115-c during a prior resource reserved by each of the UE 115-b and the UE 115-c and the first starting transmission point being the same as the second starting transmission point. In some examples, the transmission conflict may be identified independent of the first and second starting transmission points based on detecting a transmission conflict between the UE 115-b and the UE 115-c during a prior resource reserved by each of the UE 115-b and the UE 115-c.

In some examples, detecting a transmission conflict may be based on a prior starting transmission point in the first prior resource and the second prior resource being different for each of the UE 115-b and the UE 115-c and a received signal power for the first sidelink control information, the second sidelink control information, or both, satisfying a threshold.

In some examples, the transmission conflict may be identified based on an absolute reference signal received power value for the first sidelink reservation message or the second sidelink reservation message satisfying a first reference signal received power threshold, or a differential reference signal received power value between the first sidelink reservation message and the second sidelink reservation message that satisfying a second reference signal received power threshold.

In some examples, the transmission conflict may be identified based on receiving the first sidelink control information and the second sidelink control information. In some examples, the transmission conflict may be identified based on the first starting transmission point being a same point as the second starting transmission point. Additionally, or alternatively, the transmission conflict may be identified independent of the first starting transmission point and the second starting transmission point.

In some examples, the transmission conflict may be identified based on a distance between the UE 115-b and the UE 115-c determined using the first zone identifier, the first communication range parameter, the second zone identifier, the second communication range parameter, or any combination thereof.

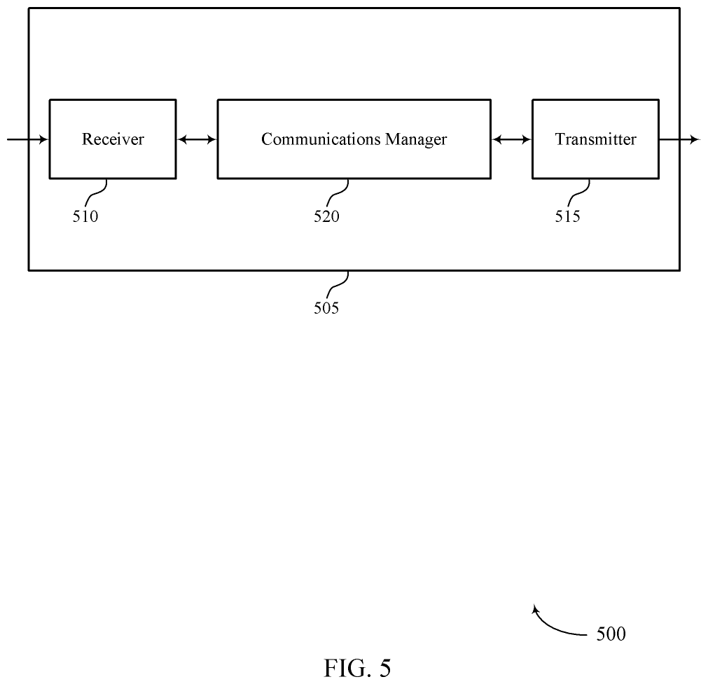

FIG. 5 illustrates a block diagram 500 of a device 505 that supports sidelink conflict determination for hidden nodes in accordance with one or more examples as disclosed herein. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to sidelink conflict determination for hidden nodes). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to sidelink conflict determination for hidden nodes). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of sidelink conflict determination for hidden nodes as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

Additionally, or alternatively, the communications manager 520 may support wireless communication by a first UE in accordance with examples as disclosed herein. For example, the communications manager 520 may be configured as or otherwise support a means for receiving, from a second UE, a first sidelink reservation message that reserves at least a first sidelink resource in a shared sidelink channel, the first sidelink reservation message that may indicate a first starting transmission point for transmission of a first message in the first sidelink resource and a first priority of the first message. The communications manager 520 may be configured as or otherwise support a means for receiving, from a third UE, a second sidelink reservation message that reserves at least a second sidelink resource in the shared sidelink channel, the second sidelink reservation message that may indicate a second starting transmission point for transmission of a second message in the second sidelink resource and a second priority of the second message. The communications manager 520 may be configured as or otherwise support a means for determining that the first sidelink resource and the second sidelink resource overlap in time and frequency. The communications manager 520 may be configured as or otherwise support a means for transmitting a conflict indication message to the second UE or the third UE based on a transmission conflict, the transmission conflict being identified based on the first and second starting transmission points and whether the second UE and the third UE are hidden nodes to one another.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, more efficient utilization of communication resources, or any combination thereof.

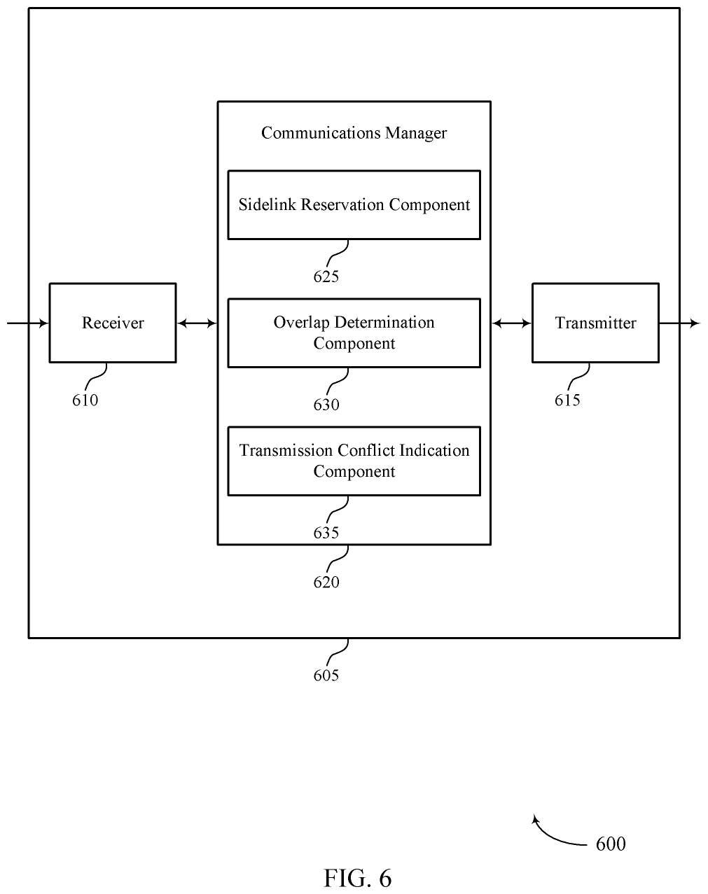

FIG. 6 illustrates a block diagram 600 of a device 605 that supports sidelink conflict determination for hidden nodes in accordance with one or more examples as disclosed herein. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to sidelink conflict determination for hidden nodes). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to sidelink conflict determination for hidden nodes). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of sidelink conflict determination for hidden nodes as described herein. For example, the communications manager 620 may include a sidelink reservation component 625, an overlap determination component 630, a transmission conflict indication component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication by a first UE in accordance with examples as disclosed herein. The sidelink reservation component 625 may be configured as or otherwise support a means for receiving, from a second UE, a first sidelink reservation message that reserves at least a first sidelink resource in a shared sidelink channel, the first sidelink reservation message that may indicate a first starting transmission point for transmission of a first message in the first sidelink resource and a first priority of the first message. The sidelink reservation component 625 may be configured as or otherwise support a means for receiving, from a third UE, a second sidelink reservation message that reserves at least a second sidelink resource in the shared sidelink channel, the second sidelink reservation message that may indicate a second starting transmission point for transmission of a second message in the second sidelink resource and a second priority of the second message. The overlap determination component 630 may be configured as or otherwise support a means for determining that the first sidelink resource and the second sidelink resource overlap in time and frequency. The transmission conflict indication component 635 may be configured as or otherwise support a means for transmitting a conflict indication message to the second UE or the third UE based on a transmission conflict, the transmission conflict being identified based on the first and second starting transmission points and whether the second UE and the third UE are hidden nodes to one another.

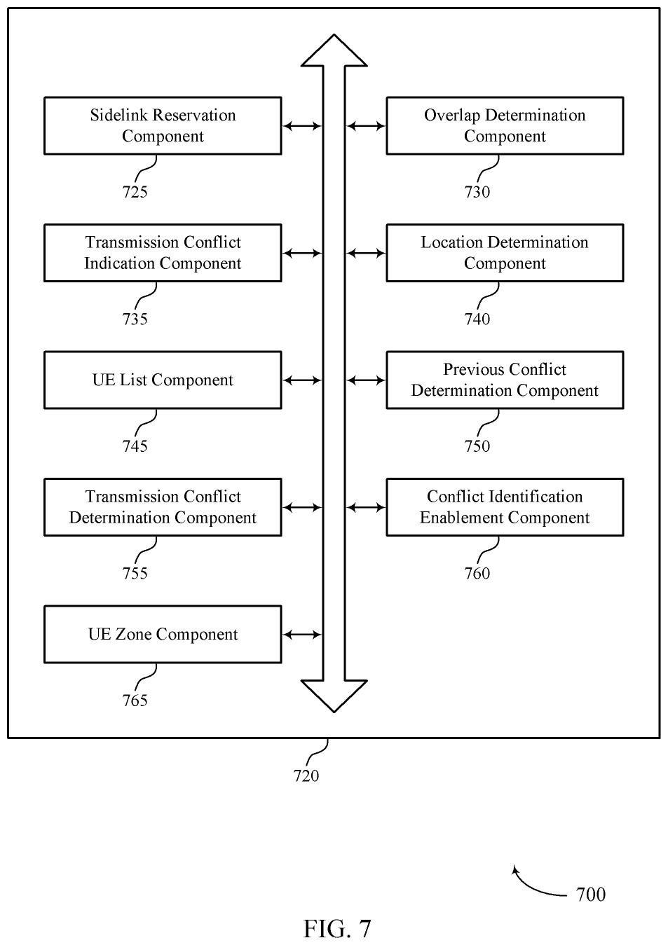

FIG. 7 illustrates a block diagram 700 of a communications manager 720 that supports sidelink conflict determination for hidden nodes in accordance with one or more examples as disclosed herein. The communications manager 720 may be an example of aspects of a communications manager 520, a communications manager 620, or both, as described herein. The communications manager 720, or various components thereof, may be an example of means for performing various aspects of sidelink conflict determination for hidden nodes as described herein. For example, the communications manager 720 may include a sidelink reservation component 725, an overlap determination component 730, a transmission conflict indication component 735, a location determination component 740, a UE list component 745, a previous conflict determination component 750, a transmission conflict determination component 755, a conflict identification enablement component 760, a UE zone component 765, or any combination thereof. Each of these components may communicate, directly or indirectly, with one another (e.g., via one or more buses).

Additionally, or alternatively, the communications manager 720 may support wireless communication by a first UE in accordance with examples as disclosed herein. The sidelink reservation component 725 may be configured as or otherwise support a means for receiving, from a second UE, a first sidelink reservation message that reserves at least a first sidelink resource in a shared sidelink channel, the first sidelink reservation message that may indicate a first starting transmission point for transmission of a first message in the first sidelink resource and a first priority of the first message. In some examples, the sidelink reservation component 725 may be configured as or otherwise support a means for receiving, from a third UE, a second sidelink reservation message that reserves at least a second sidelink resource in the shared sidelink channel, the second sidelink reservation message that may indicate a second starting transmission point for transmission of a second message in the second sidelink resource and a second priority of the second message. The overlap determination component 730 may be configured as or otherwise support a means for determining that the first sidelink resource and the second sidelink resource overlap in time and frequency. The transmission conflict indication component 735 may be configured as or otherwise support a means for transmitting a conflict indication message to the second UE or the third UE based on a transmission conflict, the transmission conflict being identified based on the first and second starting transmission points and whether the second UE and the third UE are hidden nodes to one another.

In some examples, the location determination component 740 may be configured as or otherwise support a means for receiving a first indication of a location of the second UE and a second indication of a location of the third UE. In some examples, the location determination component 740 may be configured as or otherwise support a means for where whether the second UE and the third UE are hidden nodes to one another may be based on a distance between the second UE and the third UE.

In some examples, the transmission conflict may be identified based on the distance between the second UE and the third UE satisfying a distance threshold and the first starting transmission point being the same as the second starting transmission point.

In some examples, the transmission conflict may be identified independent of the first and second starting transmission points based on the distance between the second UE and the third UE exceeding a distance threshold.

In some examples, the UE list component 745 may be configured as or otherwise support a means for receiving, from the second UE, a first list that may indicate one or more UEs associated with one or more corresponding first received signal strength indicators calculated at the second UE that exceed a first received signal strength indicator threshold. In some examples, the UE list component 745 may be configured as or otherwise support a means for receiving, from the third UE, a second list that may indicate one or more UEs associated with one or more corresponding second received signal strength indicators calculated at the third UE that exceed a second received signal strength indicator threshold. In some examples, the UE list component 745 may be configured as or otherwise support a means for where whether the second UE and the third UE are hidden nodes to one another may be based on the first list, the second list, or both.

In some examples, the transmission conflict may be identified based on the third UE being included in the first list, the second UE being included in the second list, or both and the first starting transmission point being the same as the second starting transmission point.

In some examples, the transmission conflict may be identified independent of the first and second starting transmission points based on the third UE not being included in the first list and the second UE not being included in the second list.

In some examples, the UE list component 745 may be configured as or otherwise support a means for receiving the first list and the second list via one or more broadcast transmissions, one or more groupcast transmissions, one or more unicast transmissions, or any combination thereof.

In some examples, whether the second UE and the third UE are hidden nodes to one another may be based on whether a transmission conflict was detected between the second UE and the third UE during prior resources reserved by each of the second UE and the third UE.

In some examples, the transmission conflict may be identified based on not detecting a transmission conflict between the second UE and the third UE during a prior resource reserved by each of the second UE and the third UE and the first starting transmission point being the same as the second starting transmission point.

In some examples, the transmission conflict may be identified independent of the first and second starting transmission points based on detecting a transmission conflict between the second UE and the third UE during a prior resource reserved by each of the second UE and the third UE.

In some examples, the previous conflict determination component 750 may be configured as or otherwise support a means for receiving, from the second UE, first sidelink control information scheduling a first prior resource. In some examples, the previous conflict determination component 750 may be configured as or otherwise support a means for receiving, from the third UE, second sidelink control information scheduling a second prior resource. In some examples, the overlap determination component 730 may be configured as or otherwise support a means for where the first prior resource and the second prior resource overlap in time and frequency. In some examples, the transmission conflict determination component 755 may be configured as or otherwise support a means for where detecting a transmission conflict may be based on a prior starting transmission point in the first prior resource and the second prior resource being different for each of the second UE and the third UE and a received signal power for the first sidelink control information, the second sidelink control information, or both, satisfying a threshold.

In some examples, the transmission conflict may be identified based on an absolute reference signal received power value for the first sidelink reservation message or the second sidelink reservation message satisfying a first reference signal received power threshold, or a differential reference signal received power value between the first sidelink reservation message and the second sidelink reservation message that satisfying a second reference signal received power threshold.

In some examples, the first starting transmission point and the second starting transmission point may be determined based on respective cyclic prefix extensions. In some examples, the first starting transmission point being the same as the second starting transmission point may be based on the respective cyclic prefix extensions being of a same duration.

In some examples, the conflict identification enablement component 760 may be configured as or otherwise support a means for receiving first sidelink control information that may indicate that hidden-node dependent conflict identification for the second UE may be enabled. In some examples, the conflict identification enablement component 760 may be configured as or otherwise support a means for receiving second sidelink control information that may indicate that hidden-node dependent conflict identification for the third UE may be enabled. In some examples, the transmission conflict determination component 755 may be configured as or otherwise support a means for where the transmission conflict may be identified based on receiving the first sidelink control information and the second sidelink control information.

In some examples, the conflict identification enablement component 760 may be configured as or otherwise support a means for receiving first sidelink control information from the second UE and second sidelink control information from the third UE, where at least one of the first sidelink control information and the second sidelink control information does not indicate activation of hidden-node dependent conflict identification. In some examples, the transmission conflict determination component 755 may be configured as or otherwise support a means for where the transmission conflict may be identified based on the first starting transmission point being a same point as the second starting transmission point.

In some examples, the conflict identification enablement component 760 may be configured as or otherwise support a means for receiving first sidelink control information from the second UE and second sidelink control information from the third UE, where at least one of the first sidelink control information and the second sidelink control information does not indicate activation of hidden-node conflict identification. In some examples, the transmission conflict determination component 755 may be configured as or otherwise support a means for where the transmission conflict may be identified independent of the first starting transmission point and the second starting transmission point.

In some examples, the UE zone component 765 may be configured as or otherwise support a means for receiving, from the second UE, first sidelink control information including a first zone identifier and a first communication range parameter. In some examples, the UE zone component 765 may be configured as or otherwise support a means for receiving, from the third UE, second sidelink control information including a second zone identifier and a second communication range parameter. In some examples, the transmission conflict determination component 755 may be configured as or otherwise support a means for where the transmission conflict may be identified based on a distance between the second UE and the third UE determined using the first zone identifier, the first communication range parameter, the second zone identifier, the second communication range parameter, or any combination thereof.

In some examples, the first sidelink control information, the second sidelink control information, or both, include a zone identifier field and a communication range field.

In some examples, the first sidelink control information, the second sidelink control information, or both, may be third stage sidelink control information or may be of a dedicated sidelink control information format for conflict indication.

In some examples, the UE zone component 765 may be configured as or otherwise support a means for receiving a location of the second UE, a location of the third UE, or both, via medium access control control element signaling.

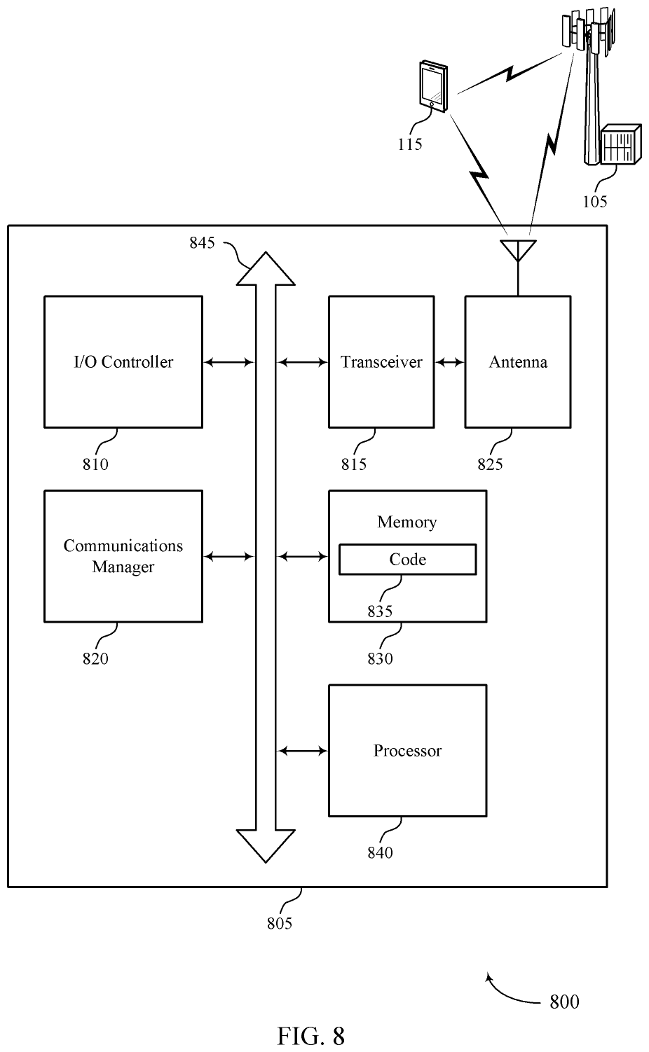

FIG. 8 illustrates a diagram of a system 800 including a device 805 that supports sidelink conflict determination for hidden nodes in accordance with one or more examples as disclosed herein. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a

general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting sidelink conflict determination for hidden nodes). For example, the device 805 or a component of the device 805 may include a processor 840 and memory 830 coupled with or to the processor 840, the processor 840 and memory 830 configured to perform various functions described herein.

Additionally, or alternatively, the communications manager 820 may support wireless communication by a first UE in accordance with examples as disclosed herein. For example, the communications manager 820 may be configured as or otherwise support a means for receiving, from a second UE, a first sidelink reservation message that reserves at least a first sidelink resource in a shared sidelink channel, the first sidelink reservation message that may indicate a first starting transmission point for transmission of a first message in the first sidelink resource and a first priority of the first message. The communications manager 820 may be configured as or otherwise support a means for receiving, from a third UE, a second sidelink reservation message that reserves at least a second sidelink resource in the shared sidelink channel, the second sidelink reservation message that may indicate a second starting transmission point for transmission of a second message in the second sidelink resource and a second priority of the second message. The communications manager 820 may be configured as or otherwise support a means for determining that the first sidelink resource and the second sidelink resource overlap in time and frequency. The communications manager 820 may be configured as or otherwise support a means for transmitting a conflict indication message to the second UE or the third UE based on a transmission conflict, the transmission conflict being identified based on the first and second starting transmission points and whether the second UE and the third UE are hidden nodes to one another.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 may be illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of sidelink conflict determination for hidden nodes as described herein, or the processor 840 and the memory 830 may be otherwise configured to perform or support such operations.

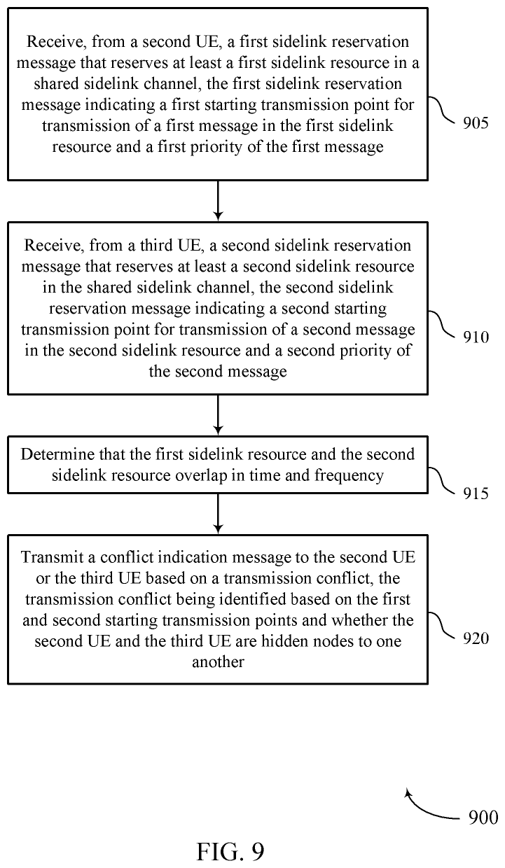

FIG. 9 illustrates a flowchart illustrating a method 900 that supports sidelink conflict determination for hidden nodes in accordance with one or more examples as disclosed herein. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving, from a second UE, a first sidelink reservation message that reserves at least a first sidelink resource in a shared sidelink channel, the first sidelink reservation message that may indicate a first starting transmission point for transmission of a first message in the first sidelink resource and a first priority of the first message. The operations of 905 may be performed in accordance with examples as disclosed herein. In some examples, aspects of the operations of 905 may be performed by a sidelink reservation component 725 as described with reference to FIG. 7.

At 910, the method may include receiving, from a third UE, a second sidelink reservation message that reserves at least a second sidelink resource in the shared sidelink channel, the second sidelink reservation message that may indicate a second starting transmission point for transmission of a second message in the second sidelink resource and a second priority of the second message. The operations of 910 may be performed in accordance with examples as disclosed herein. In some examples, aspects of the operations of 910 may be performed by a sidelink reservation component 725 as described with reference to FIG. 7.

At 915, the method may include determining that the first sidelink resource and the second sidelink resource overlap in time and frequency. The operations of 915 may be performed in accordance with examples as disclosed herein. In some examples, aspects of the operations of 915 may be performed by an overlap determination component 730 as described with reference to FIG. 7.

At 920, the method may include transmitting a conflict indication message to the second UE or the third UE based on a transmission conflict, the transmission conflict being identified based on the first and second starting transmission points and whether the second UE and the third UE are hidden nodes to one another. The operations of 920 may be performed in accordance with examples as disclosed herein. In some examples, aspects of the operations of 920 may be performed by a transmission conflict indication component 735 as described with reference to FIG. 7.

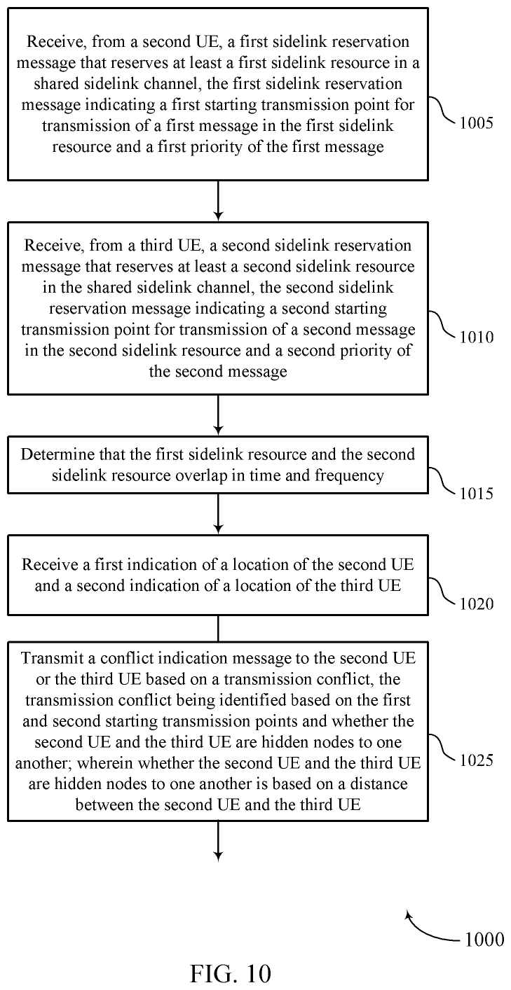

FIG. 10 illustrates a flowchart illustrating a method 1000 that supports sidelink conflict determination for hidden nodes in accordance with one or more examples as disclosed herein. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving, from a second UE, a first sidelink reservation message that reserves at least a first sidelink resource in a shared sidelink channel, the first sidelink reservation message that may indicate a first starting transmission point for transmission of a first message in the first sidelink resource and a first priority of the first message. The operations of 1005 may be performed in accordance with examples as disclosed herein. In some examples, aspects of the operations of 1005 may be performed by a sidelink reservation component 725 as described with reference to FIG. 7.

At 1010, the method may include receiving, from a third UE, a second sidelink reservation message that reserves at least a second sidelink resource in the shared sidelink channel, the second sidelink reservation message that may indicate a second starting transmission point for transmission of a second message in the second sidelink resource and a second priority of the second message. The operations of 1010 may be performed in accordance with examples as disclosed herein. In some examples, aspects of the operations of 1010 may be performed by a sidelink reservation component 725 as described with reference to FIG. 7.

At 1015, the method may include determining that the first sidelink resource and the second sidelink resource overlap in time and frequency. The operations of 1015 may be performed in accordance with examples as disclosed herein. In some examples, aspects of the operations of 1015 may be performed by an overlap determination component 730 as described with reference to FIG. 7.

At 1020, the method may include receiving a first indication of a location of the second UE and a second indication of a location of the third UE. The operations of 1020 may be performed in accordance with examples as disclosed herein. In some examples, aspects of the operations of 1020 may be performed by a location determination component 740 as described with reference to FIG. 7.

At 1025, the method may include transmitting a conflict indication message to the second UE or the third UE based on a transmission conflict, the transmission conflict being identified based on the first and second starting transmission points and whether the second UE and the third UE are hidden nodes to one another. The operations of 1025 may be performed in accordance with examples as disclosed herein. In some examples, aspects of the operations of 1025 may be performed by a transmission conflict indication component 735 as described with reference to FIG. 7. Additionally, or alternatively, at 1025 the method may include wherein whether the second UE and the third UE are hidden nodes to one another may be based on a distance between the second UE and the third UE. The operations of 1025 may be performed in accordance with examples as disclosed herein. In some examples, aspects of the operations of 1025 may be performed by a location determination component 740 as described with reference to FIG. 7.

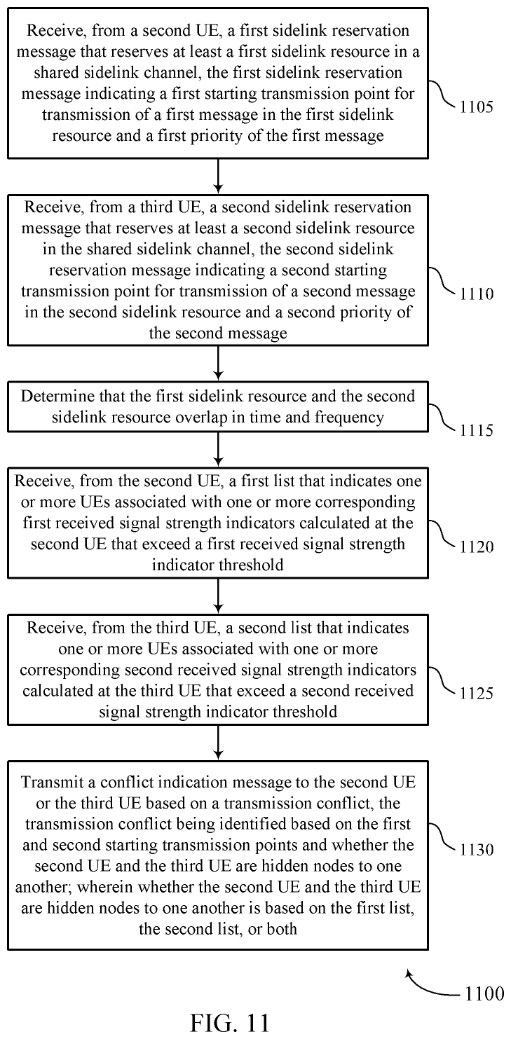

FIG. 11 illustrates a flowchart illustrating a method 1100 that supports sidelink conflict determination for hidden nodes in accordance with one or more examples as disclosed herein. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving, from a second UE, a first sidelink reservation message that reserves at least a first sidelink resource in a shared sidelink channel, the first sidelink reservation message that may indicate a first starting transmission point for transmission of a first message in the first sidelink resource and a first priority of the first message. The operations of 1105 may be performed in accordance with examples as disclosed herein. In some examples, aspects of the operations of 1105 may be performed by a sidelink reservation component 725 as described with reference to FIG. 7.

At 1110, the method may include receiving, from a third UE, a second sidelink reservation message that reserves at least a second sidelink resource in the shared sidelink channel, the second sidelink reservation message that may indicate a second starting transmission point for transmission of a second message in the second sidelink resource and a second priority of the second message. The operations of 1110 may be performed in accordance with examples as disclosed herein. In some examples, aspects of the operations of 1110 may be performed by a sidelink reservation component 725 as described with reference to FIG. 7.

At 1115, the method may include determining that the first sidelink resource and the second sidelink resource overlap in time and frequency. The operations of 1115 may be performed in accordance with examples as disclosed herein. In some examples, aspects of the operations of 1115 may be performed by an overlap determination component 730 as described with reference to FIG. 7.

At 1120, the method may include receiving, from the second UE, a first list that may indicate one or more UEs associated with one or more corresponding first received signal strength indicators calculated at the second UE that exceed a first received signal strength indicator threshold. The operations of 1120 may be performed in accordance with examples as disclosed herein. In some examples, aspects of the operations of 1120 may be performed by a UE list component 745 as described with reference to FIG. 7.

At 1125, the method may include receiving, from the third UE, a second list that may indicate one or more UEs associated with one or more corresponding second received signal strength indicators calculated at the third UE that exceed a second received signal strength indicator threshold. The operations of 1125 may be performed in accordance with examples as disclosed herein. In some examples, aspects of the operations of 1125 may be performed by a UE list component 745 as described with reference to FIG. 7.

At 1130, the method may include transmitting a conflict indication message to the second UE or the third UE based on a transmission conflict, the transmission conflict being identified based on the first and second starting transmission points and whether the second UE and the third UE are hidden nodes to one another. The operations of 1130 may be performed in accordance with examples as disclosed herein. In some examples, aspects of the operations of 1130 may be performed by a transmission conflict indication component 735 as described with reference to FIG. 7. Additionally, or alternatively, at 1130, the method may include wherein whether the second UE and the third UE are hidden nodes to one another may be based on the first list, the second list, or both. The operations of 1130 may be performed in accordance with examples as disclosed herein. In some examples, aspects of the operations of 1130 may be performed by a UE list component 745 as described with reference to FIG. 7.

The following provides an overview of aspects of the present disclosure:
Aspect 1: A method for wireless communication by a first UE, comprising: receiving, from a second UE, a first sidelink reservation message that reserves at least a first sidelink resource in a shared sidelink channel, the first sidelink reservation message indicating a first starting transmission point for transmission of a first message in the first sidelink resource and a first priority of the first message; receiving, from a third UE, a second sidelink reservation message that reserves at least a second sidelink resource in the shared sidelink channel, the second sidelink reservation message indicating a second starting transmission point for transmission of a second message in the second sidelink resource and a second priority of the second message; determining that the first sidelink resource and the second sidelink resource overlap in time and frequency; and transmitting a conflict indication message to the second UE or the third UE based at least in part on a transmission conflict, the transmission conflict being identified based at least in part on the first and second starting transmission points and whether the second UE and the third UE are hidden nodes to one another.
Aspect 2: The method of aspect 1, further comprising: receiving a first indication of a location of the second UE and a second indication of a location of the third UE; wherein whether the second UE and the third UE are hidden nodes to one another is based at least in part on a distance between the second UE and the third UE.
Aspect 3: The method of aspect 2, wherein the transmission conflict is identified based at least in part on the distance between the second UE and the third UE satisfying a distance threshold and the first starting transmission point being the same as the second starting transmission point.
Aspect 4: The method of any of aspects 2 through 3, wherein the transmission conflict is identified independent of the first and second starting transmission points based at least in part on the distance between the second UE and the third UE exceeding a distance threshold.
Aspect 5: The method of any of aspects 1 through 4, further comprising: receiving, from the second UE, a first list that indicates one or more UEs associated with one or more corresponding first received signal strength indicators calculated at the second UE that exceed a first received signal strength indicator threshold; and receiving, from the third UE, a second list that indicates one or more UEs associated with one or more corresponding second received signal strength indicators calculated at the third UE that exceed a second received signal strength indicator threshold; wherein whether the second UE and the third UE are hidden nodes to one another is based at least in part on the first list, the second list, or both.
Aspect 6: The method of aspect 5, wherein the transmission conflict is identified based at least in part on the third UE being included in the first list, the second UE being included in the second list, or both and the first starting transmission point being the same as the second starting transmission point.
Aspect 7: The method of any of aspects 5 through 6, wherein the transmission conflict is identified independent of the first and second starting transmission points based at least in part on the third UE not being included in the first list and the second UE not being included in the second list.
Aspect 8: The method of any of aspects 5 through 7, further comprising: receiving the first list and the second list via one or more broadcast transmissions, one or more groupcast transmissions, one or more unicast transmissions, or any combination thereof.
Aspect 9: The method of any of aspects 1 through 8, wherein whether the second UE and the third UE are hidden nodes to one another is based at least in part on whether a transmission conflict was detected between the second UE and the third UE during prior resources reserved by each of the second UE and the third UE.
Aspect 10: The method of aspect 9, wherein the transmission conflict is identified based at least in part on not detecting a transmission conflict between the second UE and the third UE during a prior resource reserved by each of the second UE and the third UE and the first starting transmission point being the same as the second starting transmission point.
Aspect 11: The method of any of aspects 9 through 10, wherein the transmission conflict is identified independent of the first and second starting transmission points based at least in part on detecting a transmission conflict between the second UE and the third UE during a prior resource reserved by each of the second UE and the third UE.
Aspect 12: The method of any of aspects 9 through 11, further comprising: receiving, from the second UE, first sidelink control information scheduling a first prior resource; and receiving, from the third UE, second sidelink control information scheduling a second prior resource; wherein the first prior resource and the second prior resource overlap in time and frequency; and wherein detecting a transmission conflict is based at least in part on a prior starting transmission point in the first prior resource and the second prior resource being different for each of the second UE and the third UE and a received signal power for the first sidelink control information, the second sidelink control information, or both, satisfying a threshold.
Aspect 13: The method of any of aspects 1 through 12, wherein the transmission conflict is identified based at least in part on an absolute reference signal received power value for the first sidelink reservation message or the second sidelink reservation message satisfying a first reference signal received power threshold, or a differential reference signal received power value between the first sidelink reservation message and the second sidelink reservation message that satisfying a second reference signal received power threshold.
Aspect 14: The method of any of aspects 1 through 13, wherein the first starting transmission point and the second starting transmission point are determined based at least in part on respective cyclic prefix extensions; and the first starting transmission point being the same as the second starting transmission point is based at least in part on the respective cyclic prefix extensions being of a same duration.
Aspect 15: The method of any of aspects 1 through 14, further comprising: receiving first sidelink control information indicating that hidden-node dependent conflict identification for the second UE is enabled; and receiving second sidelink control information indicating that hidden-node dependent conflict identification for the third UE is enabled; wherein the transmission conflict is identified based at least in part on receiving the first sidelink control information and the second sidelink control information.
Aspect 16: The method of any of aspects 1 through 15, further comprising: receiving first sidelink control information from the second UE and second sidelink control information from the third UE, wherein at least one of the first sidelink control information and the second sidelink control information does not indicate activation of hidden-node dependent conflict identification; wherein the transmission conflict is identified based at least in part on the first starting transmission point being a same point as the second starting transmission point.
Aspect 17: The method of any of aspects 1 through 16, further comprising: receiving first sidelink control information from the second UE and second sidelink control information from the third UE, wherein at least one of the first sidelink control information and the second sidelink control information does not indicate activation of hidden-node conflict identification; wherein the transmission conflict is identified independent of the first starting transmission point and the second starting transmission point.
Aspect 18: The method of any of aspects 1 through 17, further comprising: receiving, from the second UE, first sidelink control information comprising a first zone identifier and a first communication range parameter; and receiving, from the third UE, second sidelink control information comprising a second zone identifier and a second communication range parameter; wherein the transmission conflict is identified based at least in part on a distance between the second UE and the third UE determined using the first zone identifier, the first communication range parameter, the second zone identifier, the second communication range parameter, or any combination thereof.
Aspect 19: The method of aspect 18, wherein the first sidelink control information, the second sidelink control information, or both, comprise a zone identifier field and a communication range field.
Aspect 20: The method of any of aspects 18 through 19, wherein the first sidelink control information, the second sidelink control information, or both, are third stage sidelink control information or are of a dedicated sidelink control information format for conflict indication.
Aspect 21: The method of any of aspects 18 through 20, further comprising: receiving a location of the second UE, a location of the third UE, or both, via medium access control control element signaling.
Aspect 22: An apparatus for wireless communication by a first UE, comprising a processor; memory coupled with the processor; and instructions stored in the memory and executable by the processor to cause the apparatus to perform a method of any of aspects 1 through 21.
Aspect 23: An apparatus for wireless communication by a first UE, comprising at least one means for performing a method of any of aspects 1 through 21.
Aspect 24: A non-transitory computer-readable medium storing code for wireless communication by a first UE, the code comprising instructions executable by a processor to perform a method of any of aspects 1 through 21.

It should be noted that the methods described herein describe possible implementations, and that the operations and the steps may be rearranged or otherwise modified and that other implementations may be possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein may be applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations may be within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions may be implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection may be properly termed a computer-readable medium. For example, if the software may be transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave may be included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above may be also included within the scope of computer-readable media.

As used herein, including in the claims, “or” as used in a list of items (e.g., a list of items prefaced by a phrase such as “at least one of” or “one or more of”) may indicate an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that may be described as “based on condition A” may be based on both a condition A and a condition B without departing from the scope of the present disclosure. In other words, as used herein, the phrase “based on” shall be construed in the same manner as the phrase “based on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label may be used in the specification, the description may be applicable to any one of the similar components having the same first reference label irrespective of the second reference label, or other subsequent reference label.

The description set forth herein, in connection with the appended drawings, describes example configurations and does not represent all the examples that may be implemented or that may be within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices may be shown in block diagram form in order to avoid obscuring the concepts of the described examples.

The description herein may be provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure may be not limited to the examples and designs described herein but may be accorded the broadest scope consistent with the principles and novel features disclosed herein.

1. An apparatus for wireless communication by a first user equipment (UE), comprising:
a processor;
memory coupled with the processor; and
instructions stored in the memory and executable by the processor to cause the apparatus to:
receive, from a second UE, a first sidelink reservation message that reserves at least a first sidelink resource in a shared sidelink channel, the first sidelink reservation message indicating a first starting transmission point for transmission of a first message in the first sidelink resource and a first priority of the first message;
receive, from a third UE, a second sidelink reservation message that reserves at least a second sidelink resource in the shared sidelink channel, the second sidelink reservation message indicating a second starting transmission point for transmission of a second message in the second sidelink resource and a second priority of the second message;
determine that the first sidelink resource and the second sidelink resource overlap in time and frequency; and
transmit a conflict indication message to the second UE or the third UE based at least in part on a transmission conflict, the transmission conflict being identified based at least in part on the first and second starting transmission points and whether the second UE and the third UE are hidden nodes to one another.

2. The apparatus of claim 1, wherein the instructions are further executable by the processor to cause the apparatus to:
receive a first indication of a location of the second UE and a second indication of a location of the third UE;
wherein whether the second UE and the third UE be hidden nodes to one another is based at least in part on a distance between the second UE and the third UE.

3. The apparatus of claim 2, wherein the transmission conflict is identified based at least in part on the distance between the second UE and the third UE satisfying a distance threshold and the first starting transmission point being the same as the second starting transmission point.

4. The apparatus of claim 2, wherein the transmission conflict is identified independent of the first and second starting transmission points based at least in part on the distance between the second UE and the third UE exceeding a distance threshold.

5. The apparatus of claim 1, wherein the instructions are further executable by the processor to cause the apparatus to:
receive, from the second UE, a first list that indicates one or more UEs associated with one or more corresponding first received signal strength indicators calculated at the second UE that exceed a first received signal strength indicator threshold; and
receive, from the third UE, a second list that indicates one or more UEs associated with one or more corresponding second received signal strength indicators calculated at the third UE that exceed a second received signal strength indicator threshold;
wherein whether the second UE and the third UE be hidden nodes to one another is based at least in part on the first list, the second list, or both.

6. The apparatus of claim 5, wherein the transmission conflict is identified based at least in part on the third UE being included in the first list, the second UE being included in the second list, or both and the first starting transmission point being the same as the second starting transmission point.

7. The apparatus of claim 5, wherein the transmission conflict is identified independent of the first and second starting transmission points based at least in part on the third UE not being included in the first list and the second UE not being included in the second list.

8. The apparatus of claim 5, wherein the instructions are further executable by the processor to cause the apparatus to:
receive the first list and the second list via one or more broadcast transmissions, one or more groupcast transmissions, one or more unicast transmissions, or any combination thereof.

9. The apparatus of claim 1, wherein whether the second UE and the third UE are hidden nodes to one another is based at least in part on whether a transmission conflict was detected between the second UE and the third UE during prior resources reserved by each of the second UE and the third UE.

10. The apparatus of claim 9, wherein the transmission conflict is identified based at least in part on not detecting a transmission conflict between the second UE and the third UE during a prior resource reserved by each of the second UE and the third UE and the first starting transmission point being the same as the second starting transmission point.

11. The apparatus of claim 9, wherein the transmission conflict is identified independent of the first and second starting transmission points based at least in part on detecting a transmission conflict between the second UE and the third UE during a prior resource reserved by each of the second UE and the third UE.

12. The apparatus of claim 9, wherein the instructions are further executable by the processor to cause the apparatus to:
receive, from the second UE, first sidelink control information scheduling a first prior resource; and
receive, from the third UE, second sidelink control information scheduling a second prior resource;
wherein the first prior resource and the second prior resource overlap in time and frequency; and
wherein detect a transmission conflict is based at least in part on a prior starting transmission point in the first prior resource and the second prior resource being different for each of the second UE and the third UE and a received signal power for the first sidelink control information, the second sidelink control information, or both, satisfying a threshold.

13. The apparatus of claim 1, wherein the transmission conflict is identified based at least in part on an absolute reference signal received power value for the first sidelink reservation message or the second sidelink reservation message satisfying a first reference signal received power threshold, or a differential reference signal received power value between the first sidelink reservation message and the second sidelink reservation message that satisfying a second reference signal received power threshold.

14. The apparatus of claim 1, wherein:
the first starting transmission point and the second starting transmission point are determined based at least in part on respective cyclic prefix extensions; and
the first starting transmission point being the same as the second starting transmission point is based at least in part on the respective cyclic prefix extensions being of a same duration.

15. The apparatus of claim 1, wherein the instructions are further executable by the processor to cause the apparatus to:
receive first sidelink control information indicating that hidden-node dependent conflict identification for the second UE is enabled; and
receive second sidelink control information indicating that hidden-node dependent conflict identification for the third UE is enabled;
wherein the transmission conflict be identified based at least in part on receiving the first sidelink control information and the second sidelink control information.

16. The apparatus of claim 1, wherein the instructions are further executable by the processor to cause the apparatus to:
receive first sidelink control information from the second UE and second sidelink control information from the third UE, wherein at least one of the first sidelink control information and the second sidelink control information does not indicate activation of hidden-node dependent conflict identification;
wherein the transmission conflict be identified based at least in part on the first starting transmission point being a same point as the second starting transmission point.

17. The apparatus of claim 1, wherein the instructions are further executable by the processor to cause the apparatus to:
receive first sidelink control information from the second UE and second sidelink control information from the third UE, wherein at least one of the first sidelink control information and the second sidelink control information does not indicate activation of hidden-node conflict identification;
wherein the transmission conflict be identified independent of the first starting transmission point and the second starting transmission point.

18. The apparatus of claim 1, wherein the instructions are further executable by the processor to cause the apparatus to:
receive, from the second UE, first sidelink control information comprising a first zone identifier and a first communication range parameter; and
receive, from the third UE, second sidelink control information comprising a second zone identifier and a second communication range parameter;
wherein the transmission conflict be identified based at least in part on a distance between the second UE and the third UE determined using the first zone identifier, the first communication range parameter, the second zone identifier, the second communication range parameter, or any combination thereof.

19. The apparatus of claim 18, wherein the first sidelink control information, the second sidelink control information, or both, comprise a zone identifier field and a communication range field.

20. The apparatus of claim 18, wherein the first sidelink control information, the second sidelink control information, or both, are third stage sidelink control information or are of a dedicated sidelink control information format for conflict indication.

21-30. (canceled)
